(19) United States
(12) Patent Application Publication
(10) Pub. No.: US 2013/0231977 A1
(43) Pub. Date: Sep. 5, 2013

(54) SYSTEM, METHOD AND COMPUTER PROGRAM PRODUCT FOR ATTRIBUTING A VALUE ASSOCIATED WITH A SERIES OF USER INTERACTIONS TO INDIVIDUAL INTERACTIONS IN THE SERIES

(71) Applicants: Joseph SYNETT, Tel Aviv (IL); Arriel Johan BENIS, Gan Yavne (IL); Gilad ARMON-KEST, Amirim (IL); Moti MEIR, Modi'in (IL)

(72) Inventors: Joseph SYNETT, Tel Aviv (IL); Arriel Johan BENIS, Gan Yavne (IL); Gilad ARMON-KEST, Amirim (IL); Moti MEIR, Modi'in (IL)

(73) Assignee: KENSHOO LTD., Tel Aviv (IL)

(21) Appl. No.: 13/598,925

(22) Filed: Aug. 30, 2012

Related U.S. Application Data
(60) Provisional application No. 61/595,241, filed on Feb. 6, 2012.

(51) Int. Cl. G06Q 30/02

(52) U.S. Cl. CPC G06Q 30/0206
USPC 705/7.35

(57) ABSTRACT

A system operable to attribute a value associated with a series of user interactions to individual interactions in the series, the system including: (a) an interface, configured to obtain information of interactions which are included in the series of interactions; and (b) a processor on which an attribution module is implemented, the attribution module is configured to attribute an apportionment of the value to each out of a plurality of interactions of the series, based on a calibrated attribution scheme and on properties relating to at least one interaction out of the series of interactions, thereby enabling efficient utilization of communication resources.

### RELATED APPLICATIONS

This application claims priority from U.S. provisional patent application Ser. No. 61/595,241 filing date Feb. 6, 2012, which is incorporated herein by its entirety.

### FIELD OF THE INVENTION

This invention relates to systems, methods and computers program products for attributing a value associated with a series of user interactions to individual interactions in the series. The invention generally relates to advertisement in the digital media arena, and more particularly to attribution of a conversion amongst various digital interaction points.

### BACKGROUND OF THE INVENTION

U.S. Pat. No. 7,983,948 entitled “Systems and methods for electronic marketing” discloses an exemplary system which includes a publisher subsystem configured to communicate with an access device and an advertiser device over a data communication network. The publisher subsystem includes a publish module, a session module, and an allocation module. The publish module is configured to publish content over the data communication network, the content including an advertisement. The session module is configured to detect a selection of the advertisement, initiate a session between the access device and the advertiser device in response to the selection, the advertiser device being associated with the advertisement, and receive feedback from the advertiser device. The allocation module is configured to allocate revenue based on the feedback. In some examples, the amount of the revenue is independent of the feedback.

U.S. Pat. No. 7,870,024 entitled “Systems and methods for electronic marketing” discloses an exemplary system includes a publisher subsystem configured to communicate with an access device and an advertiser device over a data communication network. The publisher subsystem includes a publish module, a session module, and an allocation module. The publish module is configured to publish content over the data communication network, the content including an advertisement. The session module is configured to detect a selection of the advertisement, initiate a session between the access device and the advertiser device in response to the selection, the advertiser device being associated with the advertisement, and receive feedback from the advertiser device. The allocation module is configured to allocate revenue based on the feedback. In some examples, the amount of the revenue is independent of the feedback.

U.S. Pat. No. 7,827,128 entitled “System identification, estimation, and prediction of advertising-related data” discloses a system, method, and apparatus for analyzing advertisement-related data, which may include receiving data related to an aspect of an advertisement and modeling the aspect of the advertisement with a mathematical model. The mathematical model may include a control-signal-related component, a control-signal-independent component, and an error component. Each component may be updated based on at least one of a control signal, the received data, and a previous state of at least one of the components. An updated model may be created based on the updated components. The system, method, and apparatus may also include predicting the aspect of the advertisement using the updated model. Exemplary aspects of and data related to the advertisement may include one or more of the following: a number of impressions, “clicks,” or “conversions” and/or the impression-to-conversion, impression-to-click, or click-to-conversion ratios.

U.S. Pat. No. 7,653,748 entitled “Systems, methods and computer program products for integrating advertising within web content Systems”, discloses methods, and computer program products that facilitate the integration and accounting of advertising within audio Web content requested by users via telephone devices. Upon receiving a request from a user for Web content via a telephone device, a Web server retrieves an advertisement from an advertisement server, inserts the retrieved advertisement within the user requested Web content, and forwards the user requested Web content and advertisement to a text-to-speech transcoder for conversion to an audio format. The text-to-speech transcoder converts the Web content and advertisement from a text-based format to an audio format and serves the Web content and advertisement in the audio format to the user client device via a telephone link established with the user client device. If an advertisement is interactive, a text-to-speech transcoder may be configured to notify an advertisement server of user interaction with the advertisement. Information such as an identification of a requesting client device, user, as well as time and date information, may be recorded by an advertisement server for use in measuring effectiveness of a particular marketing and/or advertising campaign. Information associated with providing a user with additional information associated with an advertisement may also be stored.

U.S. Pat. No. 6,788,202 entitled “Customer conversion system” discloses a customer conversion system connects existing, conventional sensors to a point of sale computer or other computer. Entries by people into a retail space so equipped are counted and recorded on a continuous or on a periodic interval basis.

U.S. patent application publication number US2011231239A discloses a method for identifying and crediting interactions leading to a conversion, comprising acts of for each of at least one defined time interval, defining a recency factor used to scale a credit amount given to an influencing event occurring during the defined time interval; identifying at least one influencing event that influenced a conversion event; for each of the at least one influencing events, identifying a defined time interval in which the influencing event occurred and accessing the recency factor for that defined time interval; and apportioning the credit amount given to the conversion event among the at least one influencing event according to the recency factor for each influencing event.

United States Patent Application no. 20110213669 entitled “Allocation of Resources” discloses allocation of resources, and is described for example, where the resources are computers, communications network resources or advertisement slots. In an example a weighted proportional resource allocation mechanism is described in which a resource provider seeks to maximize revenue whilst users seek to maximize their satisfaction in terms of the utility of any resource allocation they receive minus any payment they make for the resource allocation. In an example, the provider determines discrimination weights (using information about resource constraints and other factors). For example, the discrimination weights are published to the users; the users submit bids for the resources in the knowledge of the discrimination weights and the provider allocates the resources according to the bids and the discrimination weights. In an example keyword auctions for sponsored search are considered where the resources are advertisement slots and where the constraints include the relative positions of the advertisements.

United States Patent Application no. 20100318432 entitled “Allocation of Internet Advertising Inventory” discloses a method for allocating inventory in a networked environment, and includes receiving a request to purchase a number of display impressions, the request including targeting parameters and a frequency constraint corresponding to a maximum number of times the advertisement can be displayed to a user. The method also includes allocating the requested number of display impressions across a set of user samples, where the number of impressions allocated to any one user sample in the set of user samples is constrained by the frequency constraint. Allocation information that defines how the impressions are allocated among the user samples is stored to a user sample database.

United States Patent Application no. 20100318413 entitled “Allocation of Internet Advertising Inventory” discloses a method for determining a price of a contract for booking advertising space in a networked environment includes receiving, via a web server, a request to book a number of impressions from available impression inventory, where each impression corresponds to the delivery of an advertisement to a browser. The method also includes assembling user samples that represent a total amount of impression inventory, where each user sample represents a number of internet users, calculating a value associated with each piece of remaining impression inventory of the total impression inventory, and evaluating the value of all remaining impression inventory before and after allocation to a contract by maximizing and equation subject to a set of constraints. The base price for the contract corresponds to the difference between the value of the inventory before and after allocation.

United States Patent Application no. 20100121679 entitled “Allocation and Pricing of Impression Segments of Online Advertisement Impressions for Advertising Campaigns” discloses an improved system and method for representative allocation and pricing of impression segments of online advertisement impressions for advertising campaigns is provided. An inventory of online advertisement impressions may be grouped in impression segments according to attributes of the advertisement impressions and advertising campaigns for impressions targeting specific attributes may be received. A representative number of advertisement impressions from the impression segments may be determined for allocation to the advertising campaigns by maximizing the prices of the impression segments for each of the values of the advertising campaigns. The representative number of advertisement impressions from the impression segments may be allocated for the advertising campaigns, and the price of each of the advertising campaigns may be output for the allocated advertisement impressions.

United States Patent Application no. 20100114689 entitled “System for display advertising optimization using click or conversion performance” discloses an advertisement impression distribution system, and includes a data processing system operable to generate an allocation plan for serving advertisement impressions. The allocation plan allocates a first portion of advertisement impressions to satisfy guaranteed demand and a second portion of advertisement impressions to satisfy non-guaranteed demand. The data processing system includes an optimizer, the optimizer to establish a relationship between the first portion of advertisement impressions and the second portion of advertisement impressions. The relationship defines a range of possible proportions of allocation of the first portion of advertisement impressions and the second portion of advertisement impressions. The optimizer generates a solution in accordance with maximizing guaranteed demand fairness, non-guaranteed demand revenue and click or conversion value, where the solution identifies a determined proportion of the first portion of advertisement impressions to serve and a determined proportion of the second portion of advertisement impressions to serve. The data processing system outputs the allocation plan including the solution to control serving of the advertisement impressions in the determined proportions.

United States Patent Application no. 20100100414 entitled “Demand Forecasting System and Method for Online Advertisements” discloses a computer implemented system, and includes a computer readable storage medium which includes historical demand data for a plurality of advertising inventories, and a processor connected to the computer readable storage medium. The processor is configured for generating a first demand forecast for a first predetermined period of time and a second demand forecast for a second predetermined period of time. The processor is configured for adjusting the first demand forecast by removing an existing demand for each of the plurality of advertising inventories, and for generating a net forecasting demand for each of the plurality of inventories for a third predetermined period of time by combining the second demand forecast and an adjusted first demand forecast. The third predetermined period of time is based on the first and second predetermined periods.

United States Patent Application no. 20100088221 entitled “Systems and Methods for the Automatic Allocation of Business Among Multiple Entities” discloses systems and methods for allocating business among a plurality of entities. In some embodiments, information about the business may be communicated from a client terminal. If the business is capable of being automatically allocated, at least one relevant parameter may be processed to identify a provider with which to allocate the business. In some embodiments, motor vehicle dealership financing application allocation techniques are used to determine financing sources, financing eligibility, financing terms, or any combination thereof in connection with the sale or leasing of motor vehicles.

United States Patent Application no. 20090234722 entitled “System and Method for Computerized Sales Optimization” discloses a method for increasing the conversion rate, or the ratio of the number of actual buyers to the number of site visitors, of a computer-implemented system such as an Internet e-commerce website. Shopping cart abandonment may be reduced though the disclosed method wherein filler items are suggested to the consumer in order to qualify the consumer for a promotional bonus, such as free shipping. By simplifying the consumer's task of selecting filler items, the consumer may be more likely to consummate the sale instead of abandoning the shopping cart to find a better deal elsewhere. In the event no suitable filler items can be identified, alternative promotions may be presented to the consumer, for example, reduced rate shipping.

United States Patent Application no. 20090106100 entitled “Method of digital good placement in a dynamic, real time environment” discloses a method and system for advertising selection, placement management, payment and delivery in a dynamic, real-time environment wherein the production, listing, procurement, payment, real time management, re-allocation and financial settlement of all types of digital advertising mediums, with optional automated delivery for advertisement and messaging for such ads is performed. The planning, purchasing, delivery and payment for on-line and traditional media advertising is automated, standardized and tracked across multiple mediums, such as TV, Internet, satellite, radio, wireless telephone, outdoor screens, and other digital mediums that display dynamic content. As a result, transparency and discovery of price, performance and availability segmented by specific markets and customer profiles for specific products is achieved. A buyer/seller real time feedback is provided to allow both buyers and sellers to dynamically change existing ads, ad space, prices, etc, in a real time environment based on real time sale/conversion feedback.

United States Patent Application no. 20080228893 entitled “Advertising management system and method with dynamic pricing” discloses a method and system for enabling advertisers to deliver advertisements to consumers in which a plurality of tiers of available advertisements, each tier containing a number of advertisements, a price for allocation of an advertisement in each tier is set wherein a lowest tier has the lowest price and the price increases to a maximum at a highest tier, and advertisements are allocated to advertisers based on availability starting from a lowest tier with unallocated advertisements and progressing to higher tiers.

United States Patent Application no. 20080228583 entitled “Advertising management system and method with dynamic pricing” discloses a method and system for enabling advertisers to deliver advertisements to consumers in which a plurality of tiers of available advertisements are defined, each tier containing a number of advertisements, a price for allocation of an advertisement in each tier is set wherein a lowest tier has the lowest price and the price increases to a maximum at a highest tier, and advertisements are allocated to advertisers based on availability starting from a lowest tier with unallocated advertisements and progressing to higher tiers.

United States Patent Application no. 20070143186 entitled “Systems, apparatuses, methods, and computer program products for optimizing allocation of an advertising budget that maximizes sales and/or profits and enabling advertisers to buy media online” discloses a system, apparatus, methods, and computer program products enabling an advertiser to increase or maximize sales and/or profits of a company, brand, and/or product by determining the optimum size of an advertising budget and/or optimizing the allocation of an advertising budget to those media channels, operators within any given media channel, program/page provided by any given operator, and/or space within any given program/page, which generates the highest ratio of sales on invested capital, maximum sales, and/or maximum profits. A system and method of enabling an advertiser to input online the parameters of an advertising campaign, including, but not limited to: the product category, the budget, the characteristics of the target customer, and the desired timing; generating an optimum allocation of said budget which generates the highest ratio of sales on invested capital, maximum sales, and/or maximum profits; enabling operators to offer online the availability of advertisement inventory on their programs/pages and/or spaces; automating the process of determining the optimum size of an advertising budget and/or optimizing the allocation of an advertising budget; integrating advertising planning and purchasing into an advertiser's enterprise resource planning system; enabling an advertiser to bid online to advertise on said programs/pages and/or spaces; and matching advertisers and operators to execute the purchase of said advertisement inventory.

United States Patent Application no. 20070033096 entitled “Method and System for Allocating Advertising Budget to Media in Online Advertising” discloses a method and system for allocating advertising budget to media in online advertising. The method provides an optimal media mix through selection and combination of media in order of high media reach estimates for respective budget allocation units based on the number of media for which budget will be executed. With the method, the media mix to optimize media effects of advertisement campaign can be simply deduced, thereby maximizing a return on investment (ROI) of a client.

### GENERAL DESCRIPTION

According to an aspect of the invention, a computerized method for attribution of a value associated with a series of interactions (e.g., user interactions) to individual interactions in the series is disclosed, the method including executing by a processor: (a) obtaining information of interactions which are included in the series of interactions; and (b) attributing an apportionment of the value to each out of a plurality of interactions of the series, based on properties relating to at least one interaction out of the series of interactions, thereby enabling efficient utilization of communication resources.

Optionally, the attributing may further be based on a calibrated attribution scheme.

Optionally, the properties includes at least one property which is unrelated to a time in which any of the interactions occurred.

Optionally, the method further includes repeatedly updating the calibrated attribution scheme, wherein each updating is based on historical data which is more recent than any of the previous instances of updating.

Optionally, the attributing includes attributing the apportionments of the value based on properties quantifying relative quality of the interactions.

Optionally, the attributing includes attributing the apportionments of the value based on types of communication channels used by the respective interactions.

Optionally, the attributing includes attributing the apportionments of the value based on properties of at least one subset of interactions of the series, wherein the subset includes multiple interactions.

Optionally, the method may further include statistically analyzing historical data of a plurality of series of interactions with at least one user (e.g., with a plurality of users) for detecting synergy between different types of interactions, wherein the attributing of the value is based on the detected synergy.

Optionally, the attributing includes attributing the apportionments of the value based on properties of elements that triggered interactions of the series.

Optionally, the attributing includes attributing the apportionments of the value based on properties which pertain to the creative media used in an advertisement involved in at least one of the respective interactions.

Optionally, the attributing includes attributing the apportionments of the value based on properties which pertain to an advertised entity associated with at least one interaction of the series of interactions.

Optionally, the attributing includes attributing the apportionments of the value based on properties of at least one keyword entered by a user which triggered at least one interaction of the series.

Optionally, the attributing includes attributing the apportionments of the value based on properties which pertain to an advertisement provided to a user in at least one of the interactions of the series.

Optionally, the attributing includes attributing the apportionments of the value based on a pattern occurring in at least one property of the interactions across the series of interactions.

Optionally, the value is based on a value of a conversion which ends the series of interactions.

Optionally, a group of value-sources on which the value is based excludes any value of a series closing conversion.

Optionally, the attributing is preceded by dividing interactions of the series into multiple groups of interactions, wherein the dividing is based on the properties of interactions of the series; wherein the attributing includes attributing at least one of the apportionments of the value to the respective interaction of the series, based on a group to which that interaction was grouped.

Optionally, the dividing is an iterative process that includes subdividing interactions of a group of interactions into multiple subgroups of interactions, wherein the dividing is based at least partly on attributes of the interactions of the series; wherein the attributing is an iterative process that includes attributing values to interactions of a subgroup based on a value assigned to a group in which the subgroup is contained.

Optionally, the dividing includes dividing interactions of the series into multiple groups of interactions based on properties of at least one user participating in interactions of the series.

Optionally, the dividing includes dividing interactions of the series into multiple groups of interactions based on properties quantifying relative quality of the interactions.

Optionally, the dividing includes dividing interactions of the series into multiple groups of interactions based on types of communication channels used by the respective interactions.

Optionally, the dividing includes dividing interactions of the series into multiple groups of interactions based on properties of at least one subset of interactions of the series, wherein the subset includes multiple interactions.

Optionally, the dividing includes dividing interactions of the series into multiple groups of interactions based on properties of elements that triggered interactions of the series.

Optionally, the dividing includes dividing interactions of the series into multiple groups of interactions based on properties which pertain to the creative media used in an advertisement involved in at least one of the respective interactions

Optionally, the dividing includes dividing interactions of the series into multiple groups of interactions based on properties which pertain to an advertised entity associated with at least one interaction of the series of interactions.

Optionally, the dividing includes dividing interactions of the series into multiple groups of interactions based on properties of at least one keyword entered by a user which triggered at least one interaction of the series.

Optionally, the dividing includes dividing interactions of the series into multiple groups of interactions based on properties which pertain to an advertisement provided to a user in at least one of the interactions of the series.

Optionally, the dividing includes dividing interactions of the series into multiple groups of interactions based on a pattern occurring in at least one property of the interactions across the series of interactions.

Optionally, the attributing includes attributing values to interactions of multiple interconnected series of user interactions which are associated with multiple users.

Optionally, the enabling of the efficient utilization of communication resources includes reducing an amount of data communicated to the user, thereby reducing an amount of communication resources.

Optionally, the attributing of the values is based on weights which are determined based on a machine implemented statistical analysis of historical data of a plurality of series of interactions with a plurality of users.

Optionally, the method further includes determining a weight (out of the aforementioned weights on which the attributing is based) for each property out of a plurality of properties of sets of interactions, wherein the determining of the weight is based on frequencies of patterns of interactions having said properties.

Optionally, the method further includes determining a weight (out of the aforementioned weights on which the attributing is based) for each property out of a plurality of properties of sets of interactions, wherein the determining of the weight is based on relative success of sets of interactions which possess the property with respect to success of other sets of interactions.

Optionally, at least one of the plurality of interactions is a conversion.

Optionally, the method further includes obtaining information indicative of relations between values previously attributed to interactions of a previously analyzed series of interactions that is associated with the conversion; wherein the attributing includes attributing values to interactions of the previously analyzed series based on the relations and on a value attributed to the conversion based at least partly on properties of at least one interaction of the series.

According to an aspect of the present invention, a system operable to attribute a value associated with a series of user interactions to individual interactions in the series is disclosed, the system including: (a) an interface, configured to obtain information of interactions which are included in the series of interactions; and (b) a processor on which an attribution module is implemented, the attribution module is configured to attribute an apportionment of the value to each out of a plurality of interactions of the series, based on properties relating to at least one interaction out of the series of interactions; thereby enabling efficient utilization of communication resources.

Optionally, the attribution module may be configured to attribute the apportionments of the value based on the properties relating to the at least one interaction and further based on a calibrated attribution scheme.

Optionally, the properties includes at least one property which is unrelated to a time in which any of the interactions occurred

Optionally, the attribution module is configured to attribute the apportionments of the value based on properties quantifying relative quality of the interactions.

Optionally, the attribution module is configured to attribute the apportionments of the value based on types of communication channels used by the respective interactions.

Optionally, the attribution module is configured to attribute the apportionments of the value based on properties of at least one subset of interactions of the series, wherein the subset includes multiple interactions.

Optionally, the attribution module is configured to attribute the apportionments of the value based on properties of elements that triggered interactions of the series.

Optionally, the attribution module is configured to attribute the apportionments of the value based on properties which pertain to the creative media used in an advertisement involved in at least one of the respective interactions

Optionally, the attribution module is configured to attribute the apportionments of the value based on properties which pertain to an advertised entity associated with at least one interaction of the series of interactions.

Optionally, the attribution module is configured to attribute the apportionments of the value based on properties of at least one keyword entered by a user which triggered at least one interaction of the series.

Optionally, the attribution module is configured to attribute the apportionments of the value based on properties which pertain to an advertisement provided to a user in at least one of the interactions of the series.

Optionally, the attribution module is configured to attribute the apportionments of the value based on a pattern occurring in at least one property of the interactions across the series of interactions.

Optionally, the value is based on a value of a conversion which ends the series of interactions.

Optionally, a group of value-sources on which the value is based excludes any value of a series closing conversion.

Optionally, a grouping module is implemented on the processor, the grouping module is configured to divide interactions of the series into multiple groups of interactions, the dividing is based on the properties of interactions of the series; wherein the attribution module is configured to attribute at least one of the apportionments of the value to the respective interaction of the series, based on a group to which that interaction was grouped.

Optionally, the grouping module is configured to divide interactions into the groups in an iterative process that includes subdividing interactions of a group of interactions into multiple subgroups of interactions, wherein the dividing is based at least partly on attributes of the interactions of the series; wherein the attribution module is configured to attribute the apportionments of the value in an iterative process that includes attributing values to interactions of a subgroup based on a value assigned to a group in which the subgroup is contained.

Optionally, the grouping module is configured to divide interactions into the groups based on properties of at least one user participating in interactions of the series.

Optionally, the grouping module is configured to divide interactions into the groups based on properties quantifying relative quality of the interactions.

Optionally, the grouping module is configured to divide interactions into the groups based on types of communication channels used by the respective interactions.

Optionally, the grouping module is configured to divide interactions into the groups based on properties of at least one subset of interactions of the series, wherein the subset includes multiple interactions.

Optionally, the grouping module is configured to divide interactions into the groups based on properties of elements that triggered interactions of the series.

Optionally, the grouping module is configured to divide interactions into the groups based on properties which pertain to the creative media used in an advertisement involved in at least one of the respective interactions

Optionally, the grouping module is configured to divide interactions into the groups based on properties which pertain to an advertised entity associated with at least one interaction of the series of interactions.

Optionally, the grouping module is configured to divide interactions into the groups based on properties of at least one keyword entered by a user which triggered at least one interaction of the series.

Optionally, the grouping module is configured to divide interactions into the groups based on properties which pertain to an advertisement provided to a user in at least one of the interactions of the series.

Optionally, the grouping module is configured to divide interactions into the groups based on a pattern occurring in at least one property of the interactions across the series of interactions.

Optionally, the attribution module is configured to attribute values to interactions of multiple interconnected series of user interactions which are associated with multiple users.

Optionally, the system enables an efficient utilization of communication resources at least by reducing an amount of data communicated to the user, thereby reducing an amount of communication resources.

Optionally, the attribution module is configured to attribute the value based on weights which are determined based on machine implemented statistical analysis of historical data of a plurality of series of interactions with a plurality of users.

Optionally, a weight determination module is implemented on the processor, the weight determination module configured to determine a weight (out of the aforementioned weights on which the attributing is based) for each property out of a plurality of properties of sets of interactions, wherein the determining of the weight is based on frequencies of patterns of interactions having said properties.

Optionally, a weight determination module is implemented on the processor, the weight determination module configured to determine a weight (out of the aforementioned weights on which the attributing is based) for each property out of a plurality of properties of sets of interactions, wherein the determining of the weight is based on relative success of sets of interactions which possess the property with respect to success of other sets of interactions.

Optionally, at least one of the plurality of interactions is a conversion.

Optionally, the interface is further configured to obtain information indicative of relations between values previously attributed to interactions of a previously analyzed series of interactions that is associated with the conversion; wherein the attribution module is configured to attribute values to interactions of the previously analyzed series based on the relations and on a value attributed to the conversion based at least partly on properties of at least one interaction of the series.

According to an aspect of the invention, a computer readable medium having computer readable code embodied therein for performing a method for attribution of a value associated with a series of user interactions to individual interactions in the series is disclosed, the computer readable code including instructions for: (a) obtaining information of interactions which are included in the series of interactions; and (b) attributing an apportionment of the value to each out of a plurality of interactions of the series, based on properties relating to at least one interaction out of the series of interactions, the properties including at least one property which is unrelated to a time in which any of the interactions occurred; thereby enabling efficient utilization of communication resources.

The computer readable code may include instructions for executing any one of the aforementioned stages, steps and processes discussed with respect to the aforementioned method.

According to an aspect of the invention, a computerized method for attribution of a value associated with a series of user interactions to individual interactions in the series is disclosed, the method including executing by a processor: (i) repeatedly updating a calibrated attribution scheme, wherein each updating is based on historical data which is more recent than any of the previous instances of updating; (ii) obtaining information of interactions which are included in the series of interactions; and (iii) attributing an apportionment of the value to each out of a plurality of interactions of the series, based on the calibrated attribution scheme and on properties relating to at least one interaction out of the series of interactions, the properties comprising at least one property which is unrelated to a time in which any of the interactions occurred; thereby enabling efficient utilization of communication resources, wherein the attributing comprises attributing the apportionments of the value based on at least one of: (a) types of communication channels used by the respective interactions; (b) properties of at least one subset of interactions of the series, wherein the subset includes multiple interactions; (c) properties of elements that triggered interactions of the series. Optionally, the attributing may include at least two and even all of (a), (b), and (c) above.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 illustrates a system operable to attribute a value associated with a series of user interactions to individual interactions in the series, according to an embodiment of the invention;

Each of FIGS. 2A through 2G illustrates a series of interactions on which various aspects of the invention may be exemplified;

FIG. 3 illustrates a computerized method for attribution of a value associated with a series of user interactions to individual interactions in the series, according to an embodiment of the invention;

FIG. 4 illustrates a computerized method for attribution of a value associated with a series of user interactions to individual interactions in the series, according to an embodiment of the invention; and

FIG. 5 illustrates a computerized method for attribution of a value associated with a series of user interactions to individual interactions in the series, according to an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “processing”, “calculating”, “determining”, “generating”, “setting”, “configuring”, “selecting”, “assigning”, “attributing”, “computing”, or the like, include action and/or processes of a computer that manipulate and/or transform data into other data, said data represented as physical quantities, e.g., such as electronic quantities, and/or said data representing the physical objects. The terms “computer”, “processor”, “processing module” and like terms should be expansively construed to cover any kind of electronic device with data processing capabilities, including, by way of non-limiting example, a personal computer, a server, a computing system, a communication device, a processor (e.g., digital signal processor (DSP), a microcontroller, a field programmable gate array (FPGA), an application specific integrated circuit (ASIC), etc.), any other electronic computing device, and or any combination thereof.

The operations in accordance with the teachings herein may be performed by a computer specially constructed for the desired purposes or by a general purpose computer specially configured for the desired purpose by a computer program stored in a computer readable storage medium.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus the appearance of the phrase “one case”, “some cases”, “other cases” or variants thereof does not necessarily refer to the same embodiment(s).

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

In embodiments of the presently disclosed subject matter one or more stages illustrated in the figures may be executed in a different order and/or one or more groups of stages may be executed simultaneously and vice versa. The figures illustrate a general schematic of the system architecture in accordance with an embodiment of the presently disclosed subject matter. Each module in the figures can be made up of any combination of software, hardware and/or firmware that performs the functions as defined and explained herein. The modules in the figures may be centralized in one location or dispersed over more than one location.

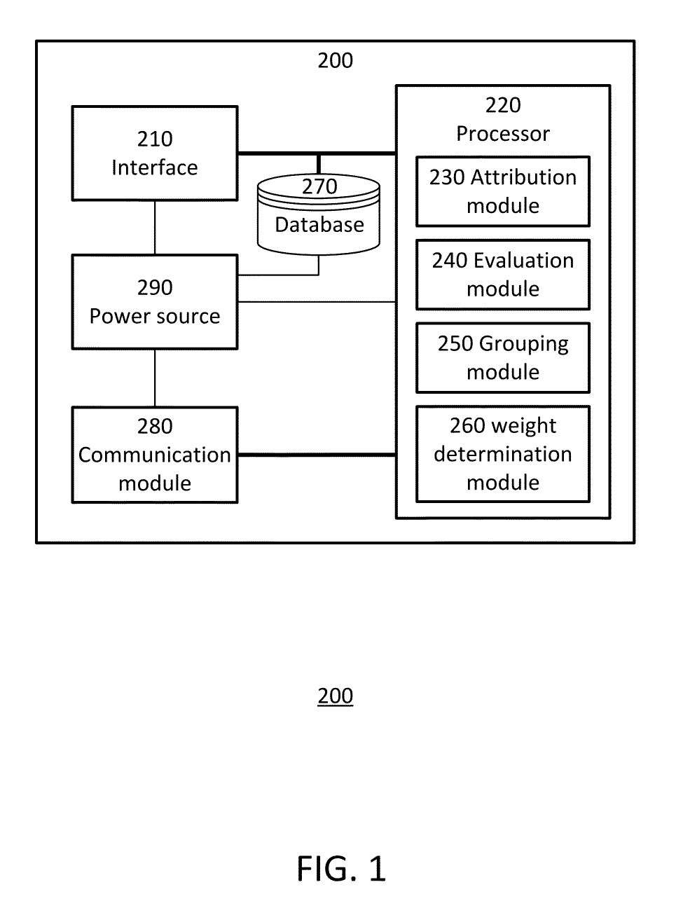

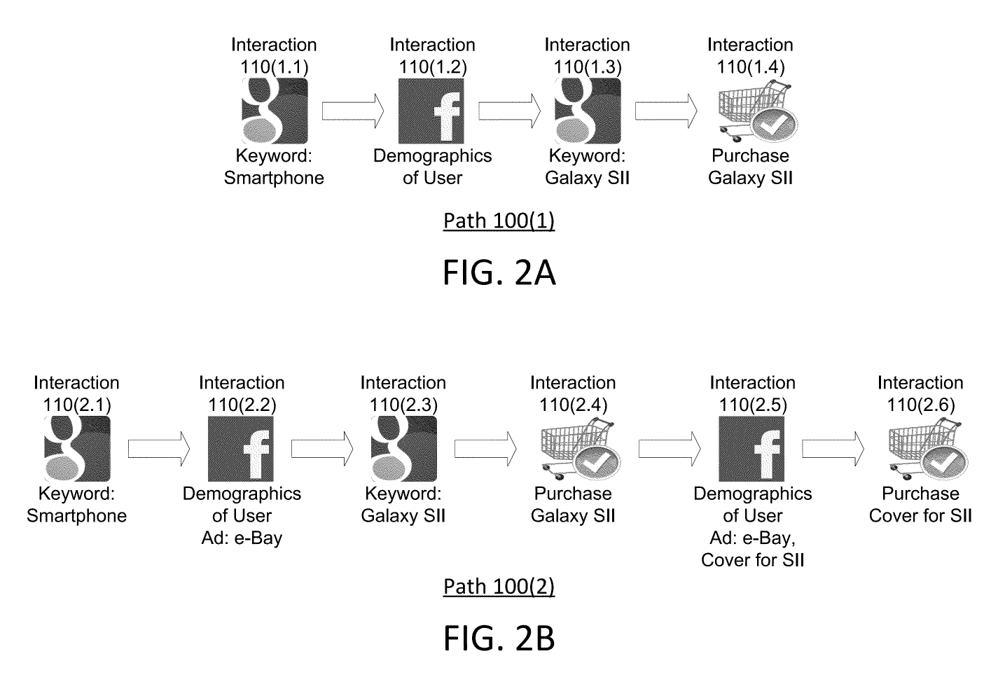

FIG. 1 illustrates system 200 which is operable to attribute a value associated with a series of user interactions to individual interactions in the series, thereby enabling efficient utilization of communication resources, according to an embodiment of the invention. System 200 includes interface 210 which is configured to obtain information of interactions which are included in the series of interactions and processor 220, on which various processing modules may be implemented. As will be clear to a person who is of skill in the art, system 200 may include various additional components (such as power source 290), which may be required or useful for effective operation of system 200. Since those components are not necessary for the understanding of the invention, they are not illustrated, thereby making the discussion clearer.

One of the modules implemented on processor 220 is attribution module 230 that is configured to attribute an apportionment of the value to each out of a plurality of interactions of the series, based on properties relating to at least one interaction out of the series of interactions.

As discussed below in greater detail, optionally the group of properties on which the attributing is based includes at least one property which is unrelated to a time in which any of the interactions occurred. Specifically, at least one of the properties is not related to any of the following:
a. a time in which any of the interactions occurred;
b. time passed between any two of more of the interactions of the series;
c. time passed between any of the interactions to another event or point in time;
d. relation of order between any two or more of the interactions of the series.

It is however noted that while not necessarily so, some of the properties of the interactions on which attribution is based may nevertheless be related to time (e.g., in addition to other properties such as the type of channel over which one or more of the interactions occurred).

The ways in which system 200 may operate according to various implementations of the invention would be clearer in view of the discussion of method 500, which may be executed by system 200. It is noted that the various implementations and variations of method 500 may be implemented by system 200 and its various components, even if not explicitly elaborated.

Optionally, the attribution module may be configured to attribute the apportionments of the value based on the properties relating to the at least one interaction and further based on a calibrated attribution scheme.

Each of FIGS. 2A through 2G illustrates a series 100 of interactions 110 on which various aspects of the invention may be exemplified. Some such series of interactions are also occasionally referred to in the art as “paths” and especially (if indeed ending with a conversion) as “path to conversion” (P2C), or as “conversion funnel”. While not necessarily so, optionally at least one of the plurality of interactions is a conversion.

FIG. 2A illustrates series 100(1) of four interactions, of which only the last is a conversion. FIG. 2B illustrates series 100(2) that includes two non consecutive conversions, one ending the series (conversion 110(2.6)) and one in its middle (conversion 110(2.4)). FIG. 2C illustrates series 100(3) that includes two-users interactions (user A and user B), wherein in some of the interactions (e.g., interactions 110(3.1) and 110(3.6)) only one of the users is a party (the other party in those examples is the marketer), and in some of the interactions (e.g., interactions 110(3.6), in which user A uses a website of the marketer to send an e-mail that includes advertising material to user B) two users are party to the interaction.

FIGS. 2D and 2E illustrate two series of interactions (110(4) and 110(5)) that do not end with a conversion but rather with another type of an interaction. In the example of FIG. 2E, the series 100(5) does not include any conversion.

Generally, among the types of interactions which may be included in the series are any engagements of a user with any digitally represented media (e.g., software, application, digital display), which contains or associates (links) to an advertiser's brand, content and products.

For simplicity of explanation, only a few types of interactions with a user are illustrated in those figures, and therefore discussed in more detail in the examples. The illustrated interactions represent:
a. Clicking by the user on an advertisement presented to him after searching a search engine (represented by a Google™ logo), e.g., interaction 110(1.1);
b. Clicking by the user on an advertisement presented to him at a social network, e.g., based on demographics (and other characteristics) of the user (represented by a Facebook™ logo), e.g., interaction 110(1.2);
c. Conversions, e.g., purchase of a product by the user, signing-in to a website or a service, etc. (represented by a shopping-cart), e.g., interaction 110(1.4);
d. Social network interactions (e.g., “liking” or sharing by the user of an advertisement, a product, or a page of an marketer, also represented by the Facebook® logo or the Like® logo), e.g., interaction 110(3.5);
e. E-mail sent to the user (e.g., triggered by the marketer or by another user, represented by an envelope), e.g., interaction 110(3.6).

Many other types of interactions are known in the art, and information thereabout may be used in the proposed systems and methods. For example, such types of interactions include: clicking on a link to a web site that appears on another's user social network page (also known as ‘news feed’ or ‘wall’ (on Facebook®); checks-in a place (i.e., proved digital notification of his current location) using a location-based social networking website for mobile devices (e.g., Foursquare®); clicking on a display advertisement (e.g., a banner), viewing an advertisement, playing a promotional video, clicking a link on a website such as Youtube™, Fanning event, and more.

It should be noted that the arrows in FIGS. 2A through 2G do not necessarily indicate a causal relationship between the two interactions (even though such relationship may indeed occur). Those arrows represent an order of the interactions in the respective series.

The series of interactions (herein referred to as S) may be a totally ordered set of interactions (i.e., fulfilling the conditions of Reflexivity {a≦a for all interactions aεS}; Antisymmetry {a≦b and b≦a implies a=b}; Transitivity {a≦b and b≦c implies a≦c}; and Comparability {for any pair of interactions of the series a,bεS, either a≦b or b≦a}. The order may be a temporal order, but this is not necessarily so.

However, in other implementations, the series is not necessarily or totally order set of interactions. For example, some implementation may require only a series which is a partially ordered set (in which only the conditions of Reflexivity, Antisymmetry, and Transitivity are required, but not the condition of Comparability). In yet additional implementations, the series is not even required to comply with all of the conditions for a partially ordered set.

Each of the interactions is associated with information regarding the interaction itself, and/or information pertaining to associated interactions, events, entities, and so on. Clearly, the information associated with each of the interactions may depend on the type of interactions.

Such information may pertain, for example, to any one or more of the following: type of the interaction, information transmitted during the interaction, length of the interaction, estimated value of the interaction, identity of one or more participants of the interaction, information regarding to more or more of the participants of the interaction, historic events which triggered the interaction, historic event which preceded the interaction, actions included in the interaction, and so on and so forth.

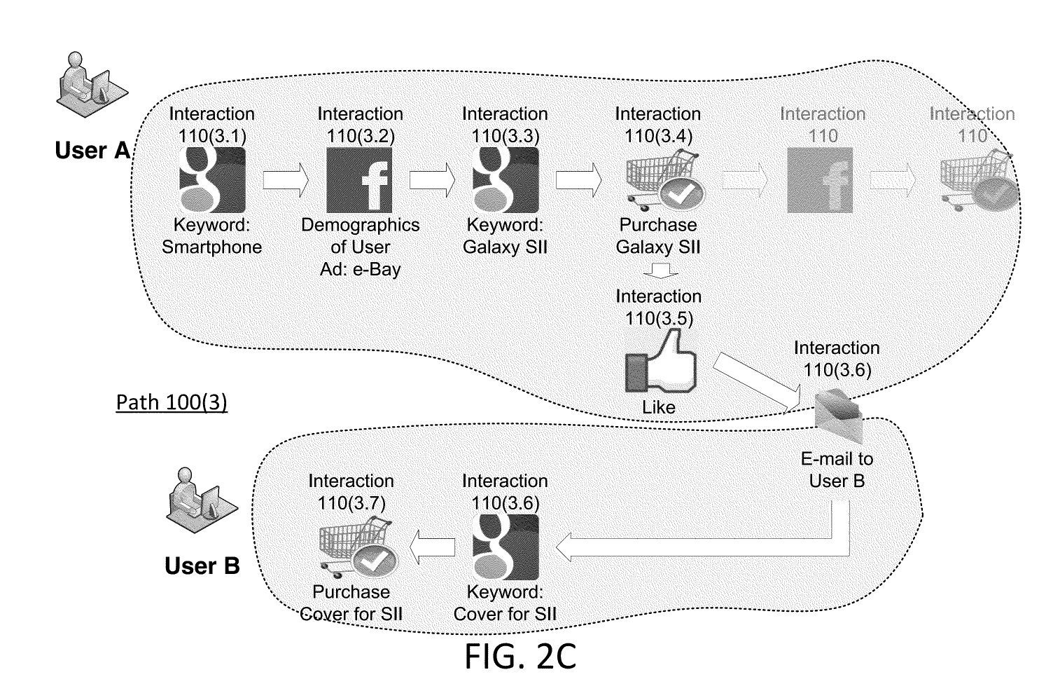

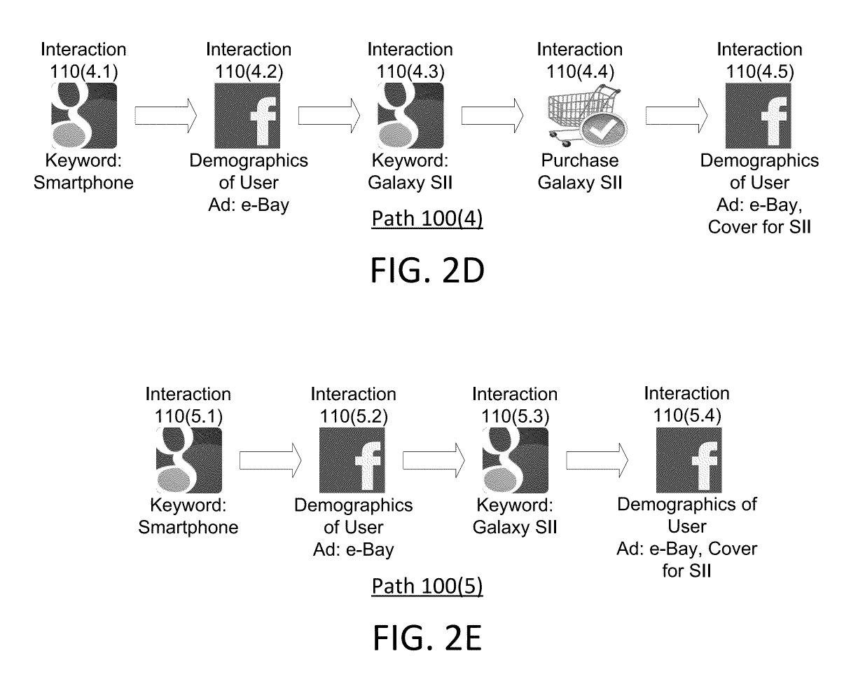

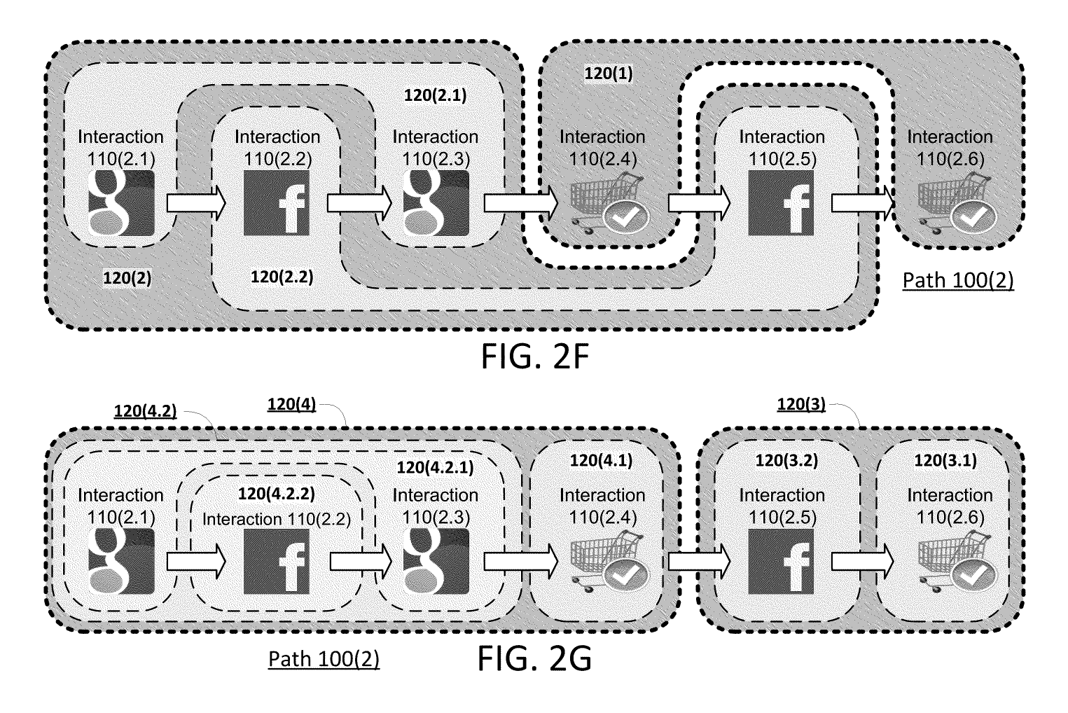

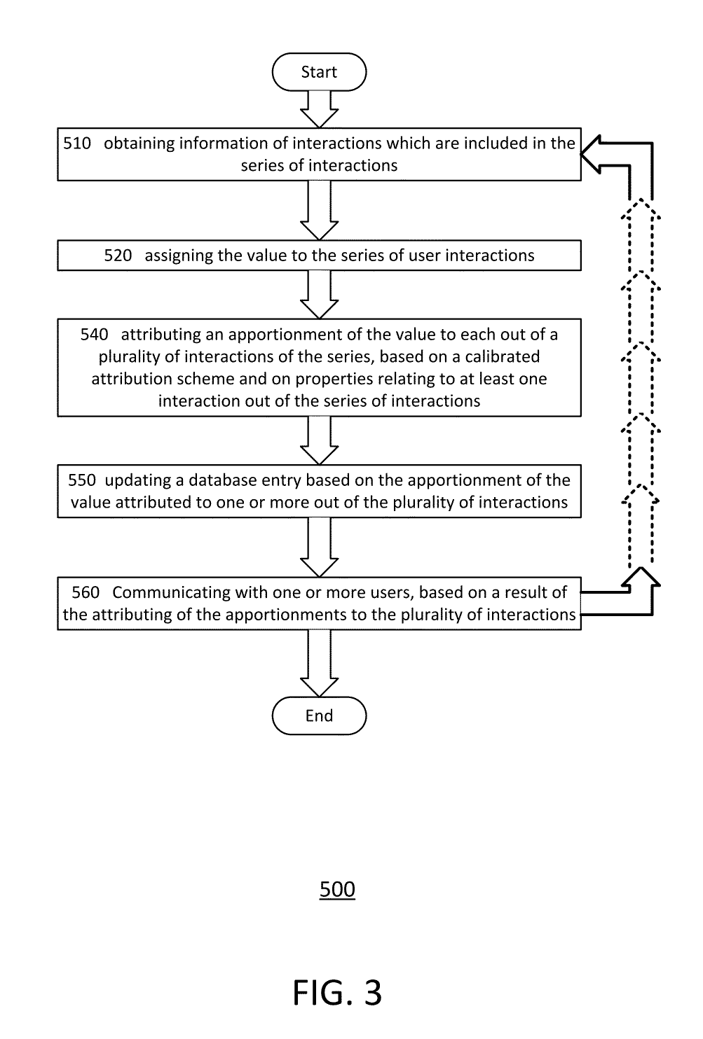

FIG. 3 illustrates computerized method 500 for attribution of a value associated with a series of user interactions to individual interactions in the series, according to an embodiment of the invention. As will be discussed below in greater detail, the attribution of the value to the various individual interactions may be used for different utilizations and/or reasons. For example, such attribution may enable efficient utilization of various communication resources (which may include advertising resources, communication hardware resources. Communication channel resources, and so on).

Referring to the examples set forth with respect to the previous drawings, method 500 may be carried out by a system such as system 200, and especially by one or more processing modules thereof (each implemented by at least one a tangible hardware processor).

The series of user interactions (few examples of which are illustrated in FIGS. 2A through 2G) may include all of the interactions (of which data exists) with a single user (or with multiple users, especially of those are related to each other, e.g., via one of the interactions), but other grouping conditions may also be applied. For example, the series may be limited only to interactions which occurred within a predefined time frame, only to interactions over preselected channels, only to interactions pertaining to a subgroup of advertised products but not to others, and so on.

One example of a series of interactions is a series of interaction which concludes with a conversion (a path to conversion). For example, a conversion may be purchasing a product online, joining a mailing list, voting in a survey, “Like”-ing, “+1”-ing or “Tweet”-ing a page on a website, “Like”-ing a page on Facebook and so on. The series of interactions may not include all of the interactions of the marketer with the user. Some interactions may be irrelevant (e.g., the user may have searched for several unrelated products but ended up purchasing only one of them), while some of the interactions may be unaccounted for (e.g., the user may have seen a billboard advertisement of the marketer, or have seen another person using the product).

It should be noted that while method 500 (and likewise system 200) are discussed as pertaining to attribution of a value which is associated with a series of interaction to individual interactions of such a series, and are exemplified mainly with respect to internet-based interactions and to advertising, they are not limited to such implementations.

Other significant fields in which method 500 (and likewise system 200) may be implemented is in production analysis in defect detection.

In production analysis, it is noted that the production of any product (e.g., an engine, a car, an engineered quartz casting, an integrated circuit, and so on) includes a series of interactions (e.g., heating for a period of time and at a prescribed temperature regime, welding, folding, cutting, polishing, etc.). The product which is yielded as the outcome of such series (or, occasionally, the failure to produce such a product) may be quantified with some value.

For example, such values may include:
a. The amount of raw material required for the generation of the product.
b. The market-value of such product.
c. The cost of the resources used in the manufacturing of the product.
d. The physical dimensions of the product.
e. The amount (and/or types) of defects in the product.

Attributing such value to the interactions (i.e., to stages of the production) according to the teachings of method 500 (and likewise by using system 200) enables an efficient utilization of production resources. For example, apportionments of the over-all cost of the resources used in the manufacturing of the product may be attributed to the different production stages, and thereafter be compared to the actual cost of each of these stages. Significant discrepancies between such actual costs and apportioned cost fraction may reveal inefficiencies in the production process.

In another example, the amount of defects may be attributed to different production stages (e.g., heating), and therefore efficient manufacture conditions (e.g., temperature regime) may be found and utilized, thereby enabling efficient utilization of production resources.

Other examples would present themselves to the ordinarily skilled reader.

Some examples of series of interactions which includes interactions with more than one user are: User A's like can trigger an interaction for user B (thus two separate interactions); User B seeing that User A ‘liked’ a product or company on his Facebook® feed, and then clicking on the link; User B seeing an Ad on Facebook® for a company or product and the Ad informed him that his friend, User A ‘liked’ that company or product (this is also referred to as a social impression).

Other examples of cross-users interactions are possible, for example, social earned media—as user A fan event (e.g., ‘like’) may be displayed on his friends (e.g., User B) social page food (e.g., wall) causing user B to interact with the advertised content through an impression, and possible other, subsequent interactions.

Stage 510 of method 500 includes obtaining information of interactions which are included in the series of interactions. Referring to the examples set forth with respect to the previous drawings, stage 510 may be carried out by an interface such as interface 210 (either by instructions from processor 220, or otherwise). The information obtained in stage 510 may pertain to all of the interactions of the series, or only to some of them. Herein below it is assumed that the series only includes interactions for which information is obtained, and it is noted that an original series may be used to define a series that only includes interactions for which information is obtained.

Stage 510 of obtaining information may include obtaining information pertaining to the individual interactions (e.g., information such as that exemplified above), and may also include obtaining information pertaining to groups of interactions (either the entire series or parts thereof). For example, information pertaining to groups of interactions may include statistics regarding the interactions (e.g., the amount of social media interactions, total time spent by the user in a website of the marketer in all of the interactions, average time between interactions, total number of interactions, time from first interaction to conversion etc.).

Stage 510 may include generating some or all of the information obtained, receiving some or all of the information obtained, and/or selecting some or all of the information obtained out of larger database.

It is noted that method 500 may also include (e.g., as part of stage 510) defining the series of interactions. For example, such a stage of defining may include selecting a group of interactions out of a larger database of interactions. Similar to the discussion above, the defining of the series may include selecting a group which includes all of the interactions that comply to one or more selection criteria: e.g., interactions with a group of one or more identified users, interactions occurring within a predefined time frame, interactions over a group of one or more preselected advertising channels, interactions pertaining to a subgroup of advertised products but not to others, and so on.

Method 500 may also include optional stage 520 of assigning the value to the series of user interactions. For example, stage 520 may be carried out by a tracking processor which processes interaction and conversion events including properties of those interactions and conversions which may be provided by a web proxy or a report. For example, the tracking processor may update the value of the path each time a conversion event is received or each time an interaction event is received.

It is noted that alternatively, stage 520 may be replaced with a stage of receiving the value of the series.

The assigning of the value may be at least partly based on input of a person (e.g., the advertiser, the e-shop owner, etc.), but may also be carried out entirely automatically. The assigning of the value may be based on value estimations of one or more conversions of the series (if any) and/or on value estimations of one or more conversions external to the series (e.g., preceding the interactions of the series of following those). Other sources of value estimation may pertain to the interactions themselves (e.g., types of interactions in the series), to one or more users who where interacted with in any of the interactions of the series (e.g., some users may be valued higher than other users), etc.

Optionally, the value of the series may be determined based on a value of a conversion which ends the series of interactions. The value of the conversion may be based on a price of a product or service purchased by the user, and may also be based on additional parameters. Various ways of evaluating conversions are known in the art, and may be practiced as part of stage 520. The value of such a conversion may not be the sole basis for the determination of the value.

Like in the series-closing conversion discussed above, the value of the conversion may be based on a price of a product or service purchased by the user, and may also be based on additional parameters. Various ways of evaluating conversions are known in the art, and may be practiced as part of stage 520. The value of such a conversion may not be the sole basis for the determination of the value.

It is noted that other parameters may be used in the determining of the value of the series, parameters which are not related to conversions. Optionally, the determining of the value to be assigned to the series may be based on a group of value-sources which excludes any value of a series-closing conversion, and possibly of other conversions as well.

Examples of parameters which may be used for evaluating the value of the series which are unrelated to conversions are “potential to convert” and the expected value of said potential conversion.

Method 500 continues with stage 540 of attributing an apportionment of the value to each out of a plurality of interactions of the series, based on properties relating to at least one interaction out of the series of interactions. Optionally, stage 540 may include attributing the respective apportionment of the value to each out of the plurality of interactions of the series, based on a calibrated attribution scheme and on the properties relating to the at least one interaction out of the series of interactions.

As discussed below in greater detail, optionally the group of properties on which the attributing of stage 540 is based includes at least one property which is unrelated to a time in which any of the interactions occurred. Specifically, at least one of the properties is not related to any of the following:
a. a time in which any of the interactions occurred;
b. time passed between any two of more of the interactions of the series;
c. time passed between any of the interactions to another event or point in time;
d. relation of order between any two or more of the interactions of the series.

It is however noted that while not necessarily so, some of the properties of the interactions on which stage 540 is based may nevertheless be related to time (e.g., in addition to other properties such as the type of channel over which one or more of the interactions occurred).

Referring to the examples set forth with respect to the previous drawings, stage 540 may be carried out by an attribution module such as attribution module 230. As will be discussed below in greater detail, the attributing of stage 540 may be based on various types of properties—each pertaining to a single interaction or to more than one interaction. Additionally, the attributing of stage 540 may be based on additional information other than the properties which relate to the at least one interactions.

The interactions-related properties on which the attributing of stage 540 is based do not pertain only (if at all) to the order of the interactions within the series. The attributing is rather based on properties of the interactions such as (although not limited to) any combination of the following types of properties:
a. properties quantifying relative quality of the interaction, of types of communication or of advertisement channels used by the respective interaction;
b. properties of at least one subset of interactions of the series, the subset including multiple interactions (e.g., combinations—i.e., ordered or unordered sequences—of interactions of different types; amount of interactions of a given type in the entire series, temporal relations between interactions (generally or these of predefined types, etc.);
c. properties of elements that triggered interactions of the series (e.g., of a keyword in an interaction that involves keywords, e.g., the length of that keyword, whether such keyword includes or otherwise pertains to a pre-identified commercial brand or other advertised entity or not, etc.).
   By way of example, such keywords may indicate a type or classification of the conducted search (which involved the keywords). Such typing may refer to the scope of the search (whether this search was relatively broad/generic, e.g., a search for “cellular phone” relatively narrow/specific, e.g., a search for “Samsung Galaxy S3”). Another typing may pertain to the assumed purpose of the search (e.g., resembling a search in an index, for finding a known website, or for finding previously unknown information; navigational/non-navigational search);
d. properties which pertain to the creative media used in an advertisement involved in at least one of the respective interactions (e.g., copy, size, content, images, videos);
e. properties which pertain to an advertised entity associated with the interaction (e.g., properties pertaining to a commercial company, a brand, a product, a service, etc.);
f. properties which pertain to an advertisement provided to a user in the interaction;
g. properties which pertain to an estimated phase of a process-to-conversion model to which the interaction belongs (e.g., attention; interest; desire; action);
h. properties of the series of interactions which pertain to the order in which interactions of different types are ordered;
i. properties of the series of interactions which pertain to elapsed time between the interactions and between the interactions and conversions;
j. properties of the user, i.e., the ‘interactor’ (e.g., its personal characteristics, its location etc.);
k. properties of the platform used for the interaction (e.g., a mobile device, a desktop etc.)

The attributing of the apportionments of the value to the respective interactions of the plurality of interactions may be used for different uses, in different implementations of the invention. Possibly, the attributing of stage 540 may enable efficient utilization of communication resources, and/or of other types of resources. This efficient utilization of resources (and especially of the communication resources) may be part of method 500, but this is not necessarily so. Such communication resources may include, for example, any combination of one or more of the following: advertising resources, communication hardware resources. Communication channel resources, and so on).

The calibrated attribution scheme on which the attributing of stage 540 may optionally be based may be implemented in different ways. An attribution scheme is a set of one or more rules according to which apportionments of the values are attributed to each out of the plurality of interactions of the series. Some attribution schemes which may be implemented may include simple rules (e.g., “evenly attribute 60% of the value between interactions associated with a brand related keyword and evenly attribute 40% of the value between the other interactions), while other possible attribution schemes may include substantially more complex rules (e.g., as discussed with respect to FIG. 2A to 2F). While some attribution schemes may be strictly deterministic, other may include some random or semi-random aspects.

An attribution scheme may be determined by an expert, regardless of any specific statistical data, or based on (solely or partly) on statistics of historical interactions logs. An example of the former is prior art order-based attribution-scheme in which 40% of the value are attributed to the first interaction of the series while 20%, 20%, and 40% are attributed to the second, third and fourth interactions respectively in a 4-interactions series.

A calibrated attribution scheme is an attribution scheme which is based on an analysis (e.g., a statistical analysis, possibly also linguistic analysis, etc.) of historical data which includes multiple series of interactions. Optionally, the historical data which is analyzed for the generation of the calibrated attribution scheme may also include the ways in which the values of some or all of these series were attributed. The calibrated attribution scheme is calibrated in that it is pertains only to series of interactions which fulfill a selection condition, and is used only to series of interactions which fulfill the same selection condition.

For example, the following calibrated attribution schemes pertain only to series of interactions which fulfill the following conditions:
a. Series of interactions which are associated with a certain advertiser.
b. Series of interactions which are associated with a certain country or jurisdiction.
c. Series of interactions which are associated with a certain line of products of a given advertiser.
d. Series of interactions which are associated with a certain vertical.

Furthermore, the calibrated attribution scheme may be an attribution scheme which is based on an analysis of partial historical data (i.e., not of all of the available historical data) which is selected out of a larger log of historical data based on compliance of the selected series (and/or interactions) with one or more such selection rules.

For example, a log of historical data which pertains to a single advertiser may be divided based on the line of product (e.g., cellular phones vs. televisions), and each of these parts may be used for the generation of a respective calibrated attribution scheme. Afterwards, a value of a series of interactions which is associated with televisions (e.g., a conversion in which a television was purchased online) would be attributed based on the attribution scheme calibrated based on the television-related historical data, while a value of a series of interactions which is associated with cellular phones (e.g., a conversion in which a charger for an iPhone™ cellular phone was purchased online) would be attributed based on the attribution scheme calibrated based on the cellular-phones-related historical data.

It is noted that the calibrated attribution scheme may be updated from time to time based on new historical data. That is, method 500 may further include repeatedly updating the calibrated attribution scheme (in regular intervals or otherwise), wherein each updating is based on historical data which is more recent than any of the previous instances of updating (that is, at least some of the historical data on which such updating is based is more recent than any of the previous instances of updating).

It is noted that this way, method 500 may be used for building and utilizing a calibrated attribution scheme that is unique to an advertiser, for attributing values to individual interactions in a series of user interactions. Such method would include executing by a processor: (a) analyzing historical data of a plurality of series of interactions with a plurality of users, each of the plurality of series including at least one interaction which is associated with the advertiser; (b) determining the calibrated attribution scheme based on results of the analyzing (e.g., by determining weights such as in stage 570); and (c) attributing a value associated with a series of user interactions, at least one of which is associated with the advertiser, to individual interactions in the series according to the previously discussed stages of method 500.

The analysis of the historical data may reflect, for example, causal relationship between interactions (interactions causing other interactions) and causal relationship between interactions and conversions. It is noted that the analysis may include analysis of series which did not contain conversions.

Method 500 may include stage 550 of updating a database entry based on the apportionment of the value attributed to one or more out of the plurality of interactions. Referring to the examples set forth with respect to the previous drawings, stage 550 may be carried out by a database such as database 270, or by a database management module (not illustrated) implemented on a processor such as processor 220. It is noted that the updating may include a stage of processing one or more of the apportionments (and possibly additional data) to determine the new value for the database entry.

The updating of stage 550 may include updating a database entry associated with one of the plurality of interactions, based on the apportionment of the value attributed to that interaction, a process which may be repeated for more than one interaction out of the plurality of interactions. The updating of stage 550 may also include updating a database entry that is associated with one or more properties of interactions (e.g., the type of interaction) based on the apportionment of the value attributed to one of more out of the plurality of interactions.

For example, the updating may include updating assessments of a potential contribution of a type of interaction to the realization of a future event. For example, one or more of the following entry types may be updated, pertaining to one or more interactions types:
An assessment of the likelihood that an interaction of the respective interaction type would lead to a conversion;
An assessment of the likelihood that an interaction of the respective interaction type would lead to an interaction of another type (e.g., the likelihood that a search-engine originated interaction would lead to a social-network based interaction).

It is noted that optionally, stage 550 may also include updating entry which pertain to a sequence of interactions, or to a sequence of interaction types. For example, one or more of the following entry types may be updated, pertaining to a sequence of interactions of one or more interactions types:
An assessment of the likelihood that a sequence of interactions of one or more interactions types (e.g., an Interaction pertaining to advertiser's brand followed by two interactions which do not pertain to that brand; three interactions within one hours, etc.) would lead to a conversion.
An assessment of the likelihood that a pattern occurring in at least one property of the interactions across a subgroup of some or all of the interactions of the series which are of one or more interactions types (e.g., an Interaction pertaining to advertiser's brand followed by two interactions which do not pertain to that brand; three interactions within one hours, etc.) would lead to a conversion
An assessment of the likelihood that that a sequence of interactions of one or more interactions types would lead to an interaction of a known type.

Generally, it is noted that one interaction may lead to another and that this other interaction may lead to a conversion. For example, an interest aroused in the client by a display ad may lead the customer to later search for the advertiser's site using a search engine. In other scenarios, two interactions in a series may be completely unconnected. Stage 550 may be implemented for detecting and/or for reflecting whether there is a causal relationship between interactions (or interaction types), and in cases where such causality does exist assign credit to both indirect and direct players in the conversion path.

That is, optionally method 500 may include statistically analyzing historical data of a plurality of series of interactions with at least one user for detecting one or more causal relationships between different interactions types (i.e., if an occurrence of one or more of these interactions type indicates high likelihood that interaction of another one of these interaction types would occur), based on an analysis of the historical data, and assigning credit to both direct and indirect interactions in the series based on the causal relationship (i.e., to interactions contributing to the conversion directly and to interactions contributing to the conversion indirectly).

In addition to causality, the updating of stage 550 may also be implemented for detecting and/or reflecting synergy. A customer looking to buy a television may be influenced by the paid search ads that appear and that they clicked on while searching for a specific model using a search engine. They could also be influenced by seeing an ad on a social networking site such as Facebook that reports that one or more of their friends “likes” a certain online electronics store. But the combined influence of seeing the same store come up in both the paid search ads and on Facebook may be larger than the influence of each of those individual engagements. The updated entries may later be used so that such synergies are detected and so that credit would be attributed appropriately when they occur.

That is, optionally method 500 may include statistically analyzing historical data of a plurality of series of interactions with a plurality of users for detecting synergy between different types of interactions, wherein the attributing of the value is based on the detected synergy. The detecting of such synergy may be a part of the statistical analysis which serves for the determination/updating of the calibrated attribution module (if implemented), and the utilizing of the synergy in the attributing may in such case be a result of utilizing the calibrated attribution scheme which reflects the detected synergy. The detection of the synergy may be explicit or implicit (i.e., the method may include detecting such synergy even if such synergy is not explicitly pointed out as “synergy”).

Method 500 may also include stage 560 of communicating with one or more users, based on a result of the attributing of the apportionments to the plurality of interactions. Referring to the examples set forth with respect to the previous drawings, stage 560 may be carried out by a communication module such as communication module 280. The communicating of stage 560 may include providing advertisements to the one or more users, or providing other information, and may also include receiving information from such one or more users.

The efficient utilization of communication or advertising resources (e.g., as part of stage 560) may be a result of utilizing the aforementioned database for future communication with the client, and especially using one of the entries updated at optional stage 550, based on the attribution of stage 540.

For example, the efficient utilization of communication resources (which may include advertising resources, communication hardware resources. Communication channel resources, and so on), enabled by the attributing of stage 540 may include reducing an amount of data communicated to the user, thereby reducing an amount of communication resources. For example, parameters of the user, and/or of a posterior possible interaction with the user may be analyzed based on the results of the attribution (e.g., based on the database referred to in the context of stage 550). If a result of the analysis is that a given interaction with the user at that opportunity should be limited or altogether avoided, a clear reduction in communication costs (financial, datalink, processing power, etc.) is obtained.

Efficient utilization of communication or advertising resources may also be achieved by better targeting the user with targeted advertising in view of the results of the attribution (e.g., based on the database referred to in the context of stage 550).

Another example of utilization of advertising resources may be changing elements which are involved in an interaction, as changing a keyword which involved in a search engine marketing (SEM) campaign in view of the results of the attribution. Yet another example of utilization, is changing inputs to other mechanisms and systems that interact or otherwise connect to the interaction, as changing the bid with respect to keywords that are involved in a search engine marketing (SEM) campaign in view of the results of the attribution.

It is noted in addition to regular uses of the term “efficiency” and its derivative forms (e.g., “efficiently”) as used herein should be expansively construed to cover ways of putting the relevant resources into good, thorough, and/or careful use, especially regarding the utilization of these resources (thereby consuming a relatively small amount of such resources for providing a desirable outcome).

Reverting to stage 540 and to the various kinds of properties which may be used in the process of attributing the apportionments of the value.

Optionally, the attributing may include attributing the apportionments of the value based on properties quantifying relative quality of the interactions. While different types of interactions (e.g., e-mails, telephone conversations, electronic advertisements, social media interactions, paper advertisements, videos watched, etc.) may be qualified by different types of quantities, many such quantified properties using for assessing quality of the interactions may be implemented, and in fact a significant variety is already used in the art. Offering only a few examples, such properties quantifying relative quality of the interactions may include:
a. Duration of the interaction (e.g., time spent on website, duration of a phone conversation, percent of video length watched by the user, etc.);
b. Amount of data transferred to the client during the interaction (e.g., amount of web pages viewed);
c. Engagement of the user in the interaction (e.g., view, mouse-over, click in, click out)

Such properties quantifying relative quality of the interactions may also quantify relative quality of a group of interactions (e.g., interactions of the same type). For example, statistic products of the above example properties (e.g., minimum, maximum, average, median, mean, standard deviation, etc.). Other examples include:
a. Parameters qualifying response of user (or users) to such interactions (e.g., bounce rate);
b. Redundancy in interactions (e.g., times in which the interaction resulted from the same keyword entered by the user);

Optionally, the attributing may include attributing the apportionments of the value based on properties of at least one keyword entered by a user which triggered at least one interaction of the series.

Optionally, the attributing may include attributing the apportionments of the value based on properties which pertain to an advertisement provided to a user in at least one of the interactions of the series. Such properties pertaining to such an advertisement may be, for example, the type of the advertisement (e.g., video, non-video, image, animated-gif, text, etc.), duration of the advertisement, size of the advertisement (in centimeters, in pixels, etc.), an affectivity score of the advertisement (e.g., based on prior success/attribution analysis), its source (e.g., being sent from a friend, being included in a social-media feed, etc.), and so on.

Optionally, the attributing may include attributing the apportionments of the value based on types of communication channels used by the respective interactions. The types of communication may be analyzed in different resolutions. By way of example, a very coarse resolution is machine interactions vs. human interactions. A finer resolution would be the interactions technology used (e.g., e-mail, video, text ad, social-media, telephone, billboard). A yet finer resolution would differentiate, for example, between video advertisements embedded in an external website to video streamed at the website of the publisher, contextual display advertising, paid/non-paid advertising, and so on.

Optionally, the attributing may include attributing the apportionments of the value based on properties of elements that triggered interactions of the series. Interactions may be triggered by actions of the user who is a party of the interaction (e.g., by entering a keyword into a search engine), by the marketer (e.g., by sending a newsletter and/or an advertisement to a mailing list of users), or by actions of another user.

The properties pertaining to such elements (or events) may be, for example, parameters of the keyword entered (e.g., its length) or other element involved in the interaction, demographic parameters of a user (e.g., age, gender), and may also be meta-parameters such as—does the keyword include a brand-name of the marketer, does the keyword include a specific product name, manufacturer or model etc. Parameters which pertain to the event which triggered the interactions may be time of the event (e.g., the time of the day in which the keyword was entered by the user), the location of the event, etc. It should be noted that while not necessarily so, the event which triggered the interaction may be another interaction (which may be part of the series, but not necessarily so).

Optionally, the attributing may include attributing the apportionments of the value based on properties of at least one keyword entered by a user which triggered at least one interaction of the series.

Optionally, the attributing may include attributing the apportionments of the value based on properties which pertain to an advertised entity associated with one or more interactions of the series of interactions. The advertised entity may be the marketer itself (for example, such a property is: whether the keyword includes the brand-name of the marketer), and may also be an advertised product or a service.

By way of example, the user may have ultimately purchased a certain type of product (say, a DELL computer). In view of this light, advertisement which were presented to this user and which advertised totally unrelated products (e.g., shoes, razor blades, etc.) may be attributed smaller apportionments than advertisements (or other types of interactions) which are more relevant to the advertised entity (e.g., ones pertaining to computers, electronic gadgets, other DELL products, etc.).

Optionally, the attributing may include attributing the apportionments of the value based on properties of at least one subset of interactions of the series, wherein the subset includes multiple interactions. The subset of interaction may be defined in different ways.

For example such properties of a subset of interactions may include:
a. Duration between two (or more) interactions of the subset;
b. Causal relations between two (or more) interactions of the subset;
c. Patterns occurring in at least one property of the interactions across the subset of interactions (e.g., considering the property Brand (B) vs. Non-Conversion (NB) as a type of a single interaction, the property of the subset may be defined is whether the pattern NB-NB-NB-B occurs in the ordered subset);
d. The number of users that were a party to at least one of the interactions (and possibly the number of interactions having at least a predefined number of users participating therein);

It should be noted that the subset may be a proper subset of the series of interactions (i.e., include a smaller number of interactions), but in other alternatives it may include the entire series of interactions. Using the terminology of a path of interactions (also referred to as “conversion funnel”, “Path to conversion” or P2C, where applicable, or possibly also just as “Path”), the attributing may include attributing the apportionments of the value based on patterns occurring in at least one property of the interactions across the series of interactions, i.e.,—across the path.

Reverting to stage 560 which includes communicating with one or more users (possibly other users than the one or more which were parties to the interactions of the series). Information about such later communication may be obtained at a later reiteration of stage 510, and the method may be repeated. It should be noted that different stages of attribution may be based on different attribution logic and/or parameters; especially if those parameters and/or logic are based on the result of the attribution (stage 540) or of posterior communication (stage 550), but also in other situations.

It is noted that while a single series of interactions may include interactions with more than one user (as in the example of FIG. 2C), and hence may be referred to as a social engagement graph, such a series may also be regarded as multiple interconnected series of interactions. Optionally, the attributing of stage 540 may include attributing values to interactions of multiple interconnected series of user interactions which are associated with multiple users.

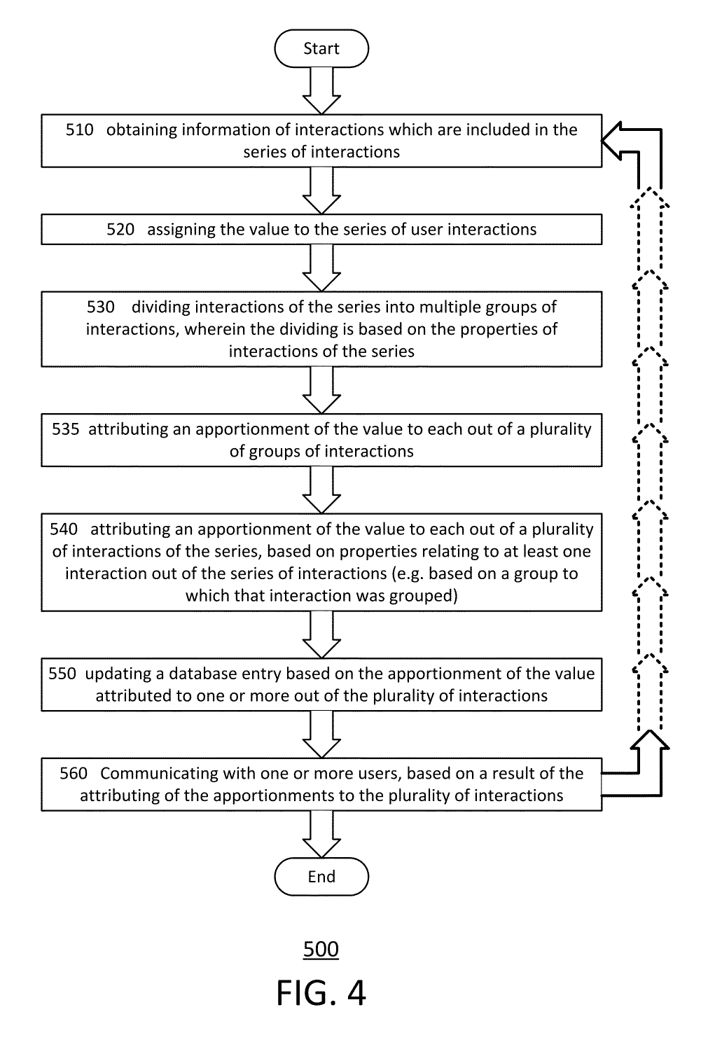

FIG. 4 illustrates computerized method 500 for attribution of a value associated with a series of user interactions to individual interactions in the series, according to an embodiment of the invention.

Optionally, stage 540 of attributing may be preceded by stage 530 of dividing interactions of the series into multiple groups of interactions, wherein the dividing is based on the properties of interactions of the series. Like before, such properties may pertain to a single interaction (e.g., channel of the interaction, quality of the interaction, duration of the interaction, etc.), and also to a groups of interactions (whether consecutive groups based on the order of the interactions in the series, or inconsecutive groups deviating from any such order). Properties which pertain to a group of interactions may be, for example, related to a pattern within one or more properties of a single interaction, across the group.

According to such an implementation of the invention, the attributing of stage 540 may include attributing at least one of the apportionments of the value to the respective interaction of the series, based on a group to which that interaction was grouped. For example, method 500 may include optional stage 535 of attributing an apportionment of the value to each out of a plurality of groups of interactions, and based upon the apportionment attributed to each of the groups, further attribute that apportionment to interactions included in the group. The attribution of the apportionments to each of the groups may be based on properties by which the interactions where grouped to that group (e.g., based on the interaction channel, in groups which includes only interactions over a certain channel), and may also be based on other properties of the interactions of the group (continuing the same example, the same group may be attributed an apportionment based on the average duration of the interactions included in that group).

Each of FIGS. 2F and 2G illustrates series 100(2) which is illustrated in FIG. 2B, after being divided as in stage 530, according to a different dividing scheme, and according to an embodiment of the invention. In the example of FIG. 2F, group 120(1) includes only interactions which are conversion, and group 120(2) includes only interactions which are not conversions.

Optionally, the dividing of stage 530 may be implemented as an iterative process that includes subdividing interactions of a group of interactions into multiple subgroups of interactions (both the dividing and any instance of subdividing may be based at least partly on attributes of the interactions of the series, and especially on those of the group/subgroup).

According to such an implementation of the invention, the attributing of stage 540 may also be an iterative process that may include attributing values to interactions of a subgroup (and possibly to the subgroup itself) based on a value assigned to a group in which the subgroup is contained.

Reverting to the example of FIG. 2F, group 120(2) may be divided into subgroup 120(2.1) which includes interactions resulting from advertisement provided to a search engine user, based on keywords he entered, and to subgroup 120(2.2) which includes interactions originating from social media activity.

In the example of FIG. 2G, an initial grouping step includes grouping the interactions of series 100(2) to groups which precede conversions (groups 120(3) and 120(4)). A second step of sub-grouping includes differentiating between the conversion of each of those subgroups to the other interactions therein. In a third step of sub-grouping, group 120(4.2) (which is the only group which includes more than one interactions after the second stage of sub-grouping) is divided again based on the channel originating the interaction—subgroup 120(4.2.1) includes interactions resulting from advertisement provided to a search engine user, based on keywords he entered, and subgroup 120(4.2.2) includes an interaction originating from social media activity.

In an iterative implementation of the attributing of stage 540 as applied to the groups of FIG. 2G, firstly a first apportionment of the value of series 100(2) is attributed to group 120(3) and a second apportionment of the value is attributed to group 120(4). The sum of the first apportionment and of the second apportionment is equal in this example to the value of series 100(2), but this is not necessarily so.

At a second step, the first apportionment of the value (the one attributed to group 120(3)) is attributed in parts to subgroups 120(3.1) and 120(3.2), or directly to the corresponding interactions 110(2.6) and 110(2.5) (because there is only one interaction in each of those subgroups). If the attribution in that step second is not done directly to interactions 110(2.6) and 110(2.5), values may be attributed to them based on the corresponding parts of the first apportionment. Like before, the parts of the apportionment of the value attributed to the group (those parts which are attributed to the subgroups) may sum to the apportionment of the value attributed to the group, but this is not necessarily so.

The second apportionment of the value (the one attributed to group 120(4)) in turn is attributed in parts to subgroups 120(4.1) and 120(4.2). The part of the second apportionment which is attributed to subgroup 120(4.2) is further attributed in parts to the subgroup of yet lower hierarchy, subgroups 120(4.2.1) and 120(4.2.2). This attribution may be based, for example, on different weights which are given to interactions originating with search engine activity and to interactions originating with social media activity. Possible techniques of determining such weights are discussed below. Other weights (or other parameters) may also be used to determine other attributions to groups and subgroups.

The attribution of value to multiple interactions in a lowest hierarchy level subgroup (e.g., subgroup 120(4.2.1)) may be implemented in different ways. For example, equal values may be attributed to each of those interactions, or attribution may be based on order or on other properties (such as any of those discussed above).

In an option which is exemplified in FIG. 2C, the dividing may include dividing interactions of the series into multiple groups of interactions based on the identify and/or the properties of at least one user participating in interactions of the series. For example, interactions may be divided into groups based on a distinction between new users to existing users. Naturally, a first interaction with a user may be included in a group of interactions with new users, while a later interaction with the very same user may be included in a group of interactions with existing users.

It should be noted that any of the properties indicated above as such by which the attribution of stage 540 may be implemented may also serve as a basis for dividing into groups in stage 530.

Optionally, the dividing may include dividing interactions of the series into multiple groups of interactions based on any one or more of the following:
a. Properties quantifying relative quality of the interactions;
b. Types of communication channels used by the respective interactions;
c. Properties of at least one subset of interactions of the series, wherein the subset includes multiple interactions;
d. Properties of elements and/or events that triggered interactions of the series;
e. Properties which pertain to an advertised entity associated with the interaction;
f. Properties of at least one keyword entered by a user which triggered at least one interaction of the series;
g. Properties which pertain to an advertisement provided to a user in at least one of the interactions of the series;
h. Patterns occurring in at least one property of the interactions across the series of interactions.

Reverting to the examples of FIG. 2G which exemplifies a grouping of the interactions of series (in the example, series 100(2)) to groups which precede conversions. It is noted that according to an embodiment of the invention, an occurrence of a conversion may trigger an attribution of a value which is based at least in part on an evaluation of that conversion. That value is attributed to interactions that belong to a series of interactions preceding the conversion (possibly including the conversion as well).

Referring to the example of FIG. 2G, an attributing of the value of conversion 110(2.4) (or a value which is based on that value) to the interactions of group 120(4.2) may be carried out before attempting to attribute the value of series 100(2) to the interactions of that series. Assuming that the value of series 100(2) is based on the value of conversion 110(2.6) in which a protective cover for a Samsung Galaxy SII™ Smartphone is purchased, there is a reason to attribute value also to the interactions preceding conversion 110(2.4), because the purchase of (or at least the interest in) the Smartphone is likely to have contributed to the process which ended with purchasing that cover. That is, value which is associated with a later conversion may be attributed to interactions which preceded (and lead) to a previous conversion of the series.

However, assuming that a relationships between the apportionment of the value of conversion 110(2.4) attributed to the various interactions of group 120(4.2) is known (e.g., it may be a result of a previous execution of method 500, but not necessarily so), those relationships may be used to attribute any value attributed to the group including that conversion 110(2.4). For example, if it is decided that 60% of the value of series 100(2) are attributed to the group of interactions including the very last conversion (group 120(3)), and that the remaining 40% are distributed between the groups corresponding to the preceding conversions of the series (in this case only group 120(4.2)), than those 40% attributed to group 120(4.2) may be attributed in parts to the interactions of group 120(4.2) based on the previously established relationships.

Therefore, method 500 may optionally include obtaining information indicative of relations between values previously attributed to interactions of a previously analyzed series of interactions (e.g., the series including the interactions of group 120(4.2)) that is associated with a conversion (e.g., conversion 110(2.4)) included in the series (e.g., series 100(2)). The obtaining of that information may be part of stage 510, may also be executed independently thereof.

The attributing of stage 540 in such an implementation may include attributing values to interactions of the previously analyzed series (e.g., the series corresponding to group 120(4.2), in this example), based on the aforementioned obtained relations, and on a value attributed to the conversion (or to the corresponding subgroup, e.g., conversion 110(2.4) or equivalently subgroup 120(4.2) in this example) based at least partly on properties of at least one interaction of the series (e.g., series 100(2) in this example).

Reverting to the dividing of the interactions into groups (exemplified in FIGS. 2F and 2G), whether implemented as an iterative process, or otherwise. The dividing of the interactions into groups may be based on a division scheme which is determined with the help of the properties of at least some of the interactions (or subsets of interactions) of the series, but this is not necessarily so. for example, the division scheme may be a predetermined scheme, or a scheme whose parameters are determined irrespectively of the specific interactions included in the specific series.

According to an embodiment of the invention, the division scheme may include an order of properties by which the interactions of the series are group. In the example of FIG. 2G, such order would be: 1. Groups pertaining to different conversions; 2. Subgroups containing the conversion vs. groups containing the rest of the interactions of the respective group; 3. Type of trigger of the interaction.

That division scheme may be determined by a human expert but may also be determined by a computer processor (e.g., based on statistics of many series of interactions). Further, the order of dividing the path into subgroups according to different dividing schemes may a pre-determined decision which can be based on past experience and statistics, or may be an output of a dynamic process.

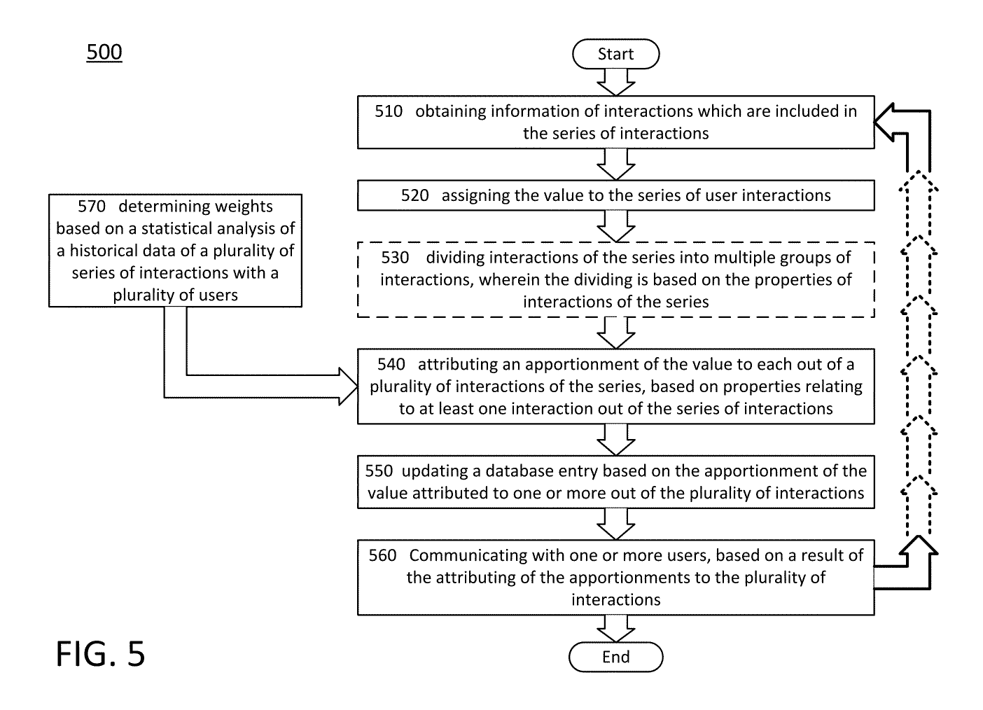

FIG. 5 illustrates computerized method 500 for attribution of a value associated with a series of user interactions to individual interactions in the series, according to an embodiment of the invention. It is noted that the attributing of the apportionments of the value to the respective interactions in stage 540 is based, as aforementioned, on properties relating to at least one interaction out of the series of interactions. The attributing may be based, for example, on weights which are given to different types of properties.

For example, it may be assumed that attribution of a value (whether that of the entire series or that attributed to a subgroup thereof) to interactions based on the number of users in each interaction may include attributing in parts 80% of that value to interactions that include only one user, and attributing in parts 20% of that value to interactions that include two users or more. While in the previous example the weights (80%, 20% in that example) are predetermined values, such weights may also be determined, according to an embodiment of the invention, based on a statistical analysis.

Method 500 may include optional stage 570 of determining weights based on a machine implemented statistical analysis of historical data of a plurality of series of interactions with a plurality of users. Referring to the examples set forth with respect to the previous drawings, stage 570 may be carried out by a weight determination module such as weight determination module 260. The attributing of the values in stage 540 may be based in such case on the weights which are determined based on the statistical analysis of the historical data of the plurality of series of interactions with a plurality of users.

Stage 570 may include, for example, determining a weight for each property out of a plurality of properties of sets of interactions, wherein the determining of the weight is based on frequencies of patterns of interactions having said properties. Such sets may include sets including a single interaction each, and/or sets that include more than one interaction each.

Stage 570 may also include, for example, determining a weight for each property out of a plurality of properties of sets of interactions, wherein the determining of the weight is based on relative success of sets of interactions which possess the property with respect to success of other sets of interactions.

Said properties may include, for example:
a. Properties quantifying relative quality of the interactions;
b. Types of communication channels used by the respective interactions;
c. Properties of at least one subset of interactions of the series, wherein the subset includes multiple interactions;
d. Properties of elements and/or events that triggered interactions of the series;
e. Properties which pertain to an advertised entity associated with the series of interactions;
f. Properties of at least one keyword entered by a user which triggered at least one interaction of the series;
g. Properties which pertain to an advertisement provided to a user in at least one of the interactions of the series;
h. Patterns occurring in at least one property of the interactions across the series of interactions.

Reverting to FIG. 1 and to system 200.

Optionally, attribution module 230 may be configured to attribute the apportionments of the value based on properties quantifying relative quality of the interactions. Optionally, attribution module 230 may be configured to attribute the apportionments of the value based on types of communication or advertisement channels used by the respective interactions.

Optionally, attribution module 230 may be configured to attribute the apportionments of the value based on properties of at least one subset of interactions of the series, wherein the subset includes multiple interactions.

Optionally, attribution module 230 may be configured to attribute the apportionments of the value based on properties of elements that triggered interactions of the series.

Optionally, attribution module 230 may be configured to attribute the apportionments of the value based on properties which pertain to an advertised entity associated with one or more interactions of the series of interactions.

Optionally, attribution module 230 may be configured to attribute the apportionments of the value based on properties of at least one keyword entered by a user which triggered at least one interaction of the series.

Optionally, attribution module 230 may be configured to attribute the apportionments of the value based on properties which pertain to an advertisement provided to a user in at least one of the interactions of the series.

Optionally, attribution module 230 may be configured to attribute the apportionments of the value based on a pattern occurring in at least one property of the interactions across the series of interactions.

Optionally, evaluation module 240 may be implemented on processor 220, the attribution module configured to determine the value of the series of interactions. Optionally, the value may be based on a value of a conversion which ends the series of interactions. Optionally, a group of value-sources on which the value may be based excludes any value of a series closing conversion.

Optionally, a grouping module 250 may be implemented on the processor, the grouping module is configured to divide interactions of the series into multiple groups of interactions, the dividing is based on the properties of interactions of the series; wherein attribution module 230 is configured to attribute at least one of the apportionments of the value to the respective interaction of the series, based on a group to which that interaction was grouped.

Optionally, grouping module 250 may be configured to divide interactions into the groups in an iterative process that comprises subdividing interactions of a group of interactions into multiple subgroups of interactions, wherein the dividing is based at least partly on attributes of the interactions of the series; wherein attribution module 230 is configured to attribute the apportionments of the value in an iterative process that comprises attributing values to interactions of a subgroup based on a value assigned to a group in which the subgroup is contained.

Optionally, grouping module 250 may be configured to divide interactions into the groups based on properties of at least one user participating in interactions of the series.

Optionally, grouping module 250 may be configured to divide interactions into the groups based on properties quantifying relative quality of the interactions. Optionally, grouping module 250 may be configured to divide interactions into the groups based on types of communication channels used by the respective interactions.

Optionally, grouping module 250 may be configured to divide interactions into the groups based on properties of at least one subset of interactions of the series, wherein the subset includes multiple interactions.

Optionally, grouping module 250 may be configured to divide interactions into the groups based on properties of elements that triggered interactions of the series.

Optionally, grouping module 250 may be configured to divide interactions into the groups based on properties which pertain to an advertised entity associated with one or more interactions of the series of interactions. Optionally, grouping module 250 may be configured to divide interactions into the groups based on properties of at least one keyword entered by a user which triggered at least one interaction of the series.

Optionally, grouping module 250 may be configured to divide interactions into the groups based on properties which pertain to an advertisement provided to a user in at least one of the interactions of the series.

Optionally, grouping module 250 may be configured to divide interactions into the groups based on a pattern occurring in at least one property of the interactions across the series of interactions.

Optionally, attribution module 230 may be configured to attribute values to interactions of multiple interconnected series of user interactions which are associated with multiple users.

Optionally, the system enables an efficient utilization of communication resources at least by reducing an amount of data communicated to the user, thereby reducing an amount of communication resources. Optionally, attribution module 230 may be configured to attribute the value based on weights which are determined based on a statistical analysis of historical data of a plurality of series of interactions with a plurality of users.

Optionally, weight determination module 260 may be implemented on the processor. Optionally, weight determination module 260 may be configured to determine a weight for each property out of a plurality of properties of sets of interactions, wherein the determining of the weight is based on frequencies of patterns of interactions having said properties.

Optionally, weight determination module 260 may be configured to determine a weight for each property out of a plurality of properties of sets of interactions, wherein the determining of the weight is based on relative success of sets of interactions which possess the property with respect to success of other sets of interactions.

Optionally, weight determination module 260 may be configured to repeatedly update the calibrated attribution scheme (in regular intervals or otherwise), wherein each updating is based on historical data which is more recent than any of the previous instances of updating (that is, at least some of the historical data on which such updating is based is more recent than any of the previous instances of updating).

Optionally, interface 210 may be further configured to obtain information indicative of relations between values previously attributed to interactions of a previously analyzed series of interactions that is associated with the conversion; wherein attribution module 230 is configured to attribute values to interactions of the previously analyzed series based on the relations and on a value attributed to the conversion based at least partly on properties of at least one interaction of the series.

It will also be understood that the system according to the invention may be a suitably programmed computer. Likewise, the invention contemplates a computer program being readable by a computer for executing method 500 discussed above, and any of its variations. The invention further contemplates a machine-readable memory tangibly embodying a program of instructions executable by the machine for executing method 500 discussed above, and any of its variations.

It will also be understood that the system according to the invention may be a suitably programmed computer. Likewise, the invention contemplates a computer program being readable by a computer for executing method 500. The invention further contemplates a machine-readable memory tangibly embodying a program of instructions executable by the machine for executing the method of the invention.

A computer readable medium is disclosed, having computer readable code embodied therein for performing a method for attribution of a value associated with a series of user interactions to individual interactions in the series, the computer readable code including instructions for: (a) obtaining information of interactions which are included in the series of interactions; and (b) attributing an apportionment of the value to each out of a plurality of interactions of the series, based on properties relating to at least one interaction out of the series of interactions, the properties including at least one property which is unrelated to a time in which any of the interactions occurred; thereby enabling efficient utilization of communication resources.

Optionally, the instructions included in the computer readable code for attributing include instructions for attributing the apportionments of the value based on properties quantifying relative quality of the interactions.

Optionally, the instructions included in the computer readable code for attributing include instructions for attributing the apportionments of the value based on types of communication channels used by the respective interactions.

Optionally, the instructions included in the computer readable code for attributing include instructions for attributing the apportionments of the value based on properties of at least one subset of interactions of the series, wherein the subset includes multiple interactions.

Optionally, the instructions included in the computer readable code for attributing include instructions for attributing the apportionments of the value based on properties of elements that triggered interactions of the series.

Optionally, the instructions included in the computer readable code for attributing include instructions for attributing the apportionments of the value based on properties which pertain to an advertised entity associated with at least one interaction of the series of interactions.

Optionally, the instructions included in the computer readable code for attributing include instructions for attributing the apportionments of the value based on properties of at least one keyword entered by a user which triggered at least one interaction of the series.

Optionally, the instructions included in the computer readable code for attributing include instructions for attributing the apportionments of the value based on properties which pertain to an advertisement provided to a user in at least one of the interactions of the series.

Optionally, the instructions included in the computer readable code for attributing include instructions for attributing the apportionments of the value based on a pattern occurring in at least one property of the interactions across the series of interactions.

Optionally, a group of value-sources on which the value is based excludes any value of a series closing conversion.

Optionally, the computer readable code further includes instructions for executing, prior to the attributing, dividing interactions of the series into multiple groups of interactions, wherein the dividing is based on the properties of interactions of the series; wherein the attributing includes attributing at least one of the apportionments of the value to the respective interaction of the series, based on a group to which that interaction was grouped.

Optionally, the instructions included in the computer readable code for dividing include instructions for executing an iterative dividing process that includes subdividing interactions of a group of interactions into multiple subgroups of interactions, wherein the dividing is based at least partly on attributes of the interactions of the series; wherein the attributing is an iterative process that includes attributing values to interactions of a subgroup based on a value assigned to a group in which the subgroup is contained.

Optionally, the instructions included in the computer readable code for attributing include instructions for attributing values to interactions of multiple interconnected series of user interactions which are associated with multiple users.

Optionally, the enabling of the efficient utilization of communication resources includes reducing an amount of data communicated to the user, thereby reducing an amount of communication resources.

Optionally, the instructions included in the computer readable code for attributing include instructions for attributing the values is based on weights which are determined based on a statistical analysis of historical data of a plurality of series of interactions with a plurality of users.

Optionally, the computer readable code further includes instructions for including determining a weight for each property out of a plurality of properties of sets of interactions, wherein the determining of the weight is based on frequencies of patterns of interactions having said properties.

Optionally, the computer readable code further includes instructions for determining a weight for each property out of a plurality of properties of sets of interactions, wherein the determining of the weight is based on relative success of sets of interactions which possess the property with respect to success of other sets of interactions.

Optionally, at least one out of the plurality of interactions is a conversion.

Optionally, the computer readable code further includes instructions for obtaining information indicative of relations between values previously attributed to interactions of a previously analyzed series of interactions that is associated with the conversion; wherein the attributing includes attributing values to interactions of the previously analyzed series based on the relations and on a value attributed to the conversion based at least partly on properties of at least one interaction of the series.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It will be appreciated that the embodiments described above are cited by way of example, and various features thereof and combinations of these features can be varied and modified.

While various embodiments have been shown and described, it will be understood that there is no intent to limit the invention by such disclosure, but rather, it is intended to cover all modifications and alternate constructions falling within the scope of the invention, as defined in the appended claims.

What is claimed is:

1. A computerized method for attribution of a value associated with a series of user interactions to individual interactions in the series, the method comprising executing by a processor:
obtaining information of interactions which are included in the series of interactions; and
attributing an apportionment of the value to each out of a plurality of interactions of the series, based on a calibrated attribution scheme and on properties relating to at least one interaction out of the series of interactions, thereby enabling efficient utilization of communication resources.

2. A computerized method for building and utilizing a calibrated attribution scheme that is unique to an advertiser, for attributing a value to individual interactions in a series of user interactions, the method comprising executing by a processor:
analyzing historical data of a plurality of series of interactions with a plurality of users, each of the plurality of series including at least one interaction which is associated with the advertiser;
determining the calibrated attribution scheme based on results of the analyzing; and
attributing a value associated with a series of user interactions, at least one of which is associated with the advertiser, to individual interactions in the series according to the method of claim 1.

3. The method according to claim 1, wherein the properties comprising at least one property which is unrelated to a time in which any of the interactions occurred.

4. The method according to claim 1, further comprising repeatedly updating the calibrated attribution scheme, wherein each updating is based on historical data which is more recent than any of the previous instances of updating.

5. The method according to claim 1, further comprising statistically analyzing historical data of a plurality of series of interactions with at least one user for detecting synergy between different types of interactions, wherein the attributing of the value is based on the detected synergy.

6. The method according to claim 1, wherein the attributing comprises attributing the apportionments of the value based on properties quantifying relative quality of the interactions.

7. The method according to claim 1, wherein the attributing comprises attributing the apportionments of the value based on types of communication channels used by the respective interactions.

8. The method according to claim 1, wherein the attributing comprises attributing the apportionments of the value based on properties of at least one subset of interactions of the series, wherein the subset includes multiple interactions.

9. The method according to claim 1, wherein the attributing comprises attributing the apportionments of the value based on properties of elements that triggered interactions of the series.

10. The method according to claim 1, wherein the attributing comprises attributing the apportionments of the value based on properties which pertain to an advertised entity associated with at least one interaction of the series of interactions.

11. The method according to claim 1, wherein the attributing comprises attributing the apportionments of the value based on properties of at least one keyword entered by a user which triggered at least one interaction of the series.

12. The method according to claim 1, wherein the attributing comprises attributing the apportionments of the value based on properties which pertain to an advertisement provided to a user in at least one of the interactions of the series.

13. The method according to claim 1, wherein the attributing comprises attributing the apportionments of the value based on a pattern occurring in at least one property of the interactions across the series of interactions.

14. The method according to claim 1, wherein a group of value-sources on which the value is based excludes any value of a series closing conversion.

15. The method according to claim 1, wherein the attributing is preceded by dividing interactions of the series into multiple groups of interactions, wherein the dividing is based on the properties of interactions of the series; wherein the attributing comprises attributing at least one of the apportionments of the value to the respective interaction of the series, based on a group to which that interaction was grouped.

16. The method according to claim 15, wherein the dividing is an iterative process that comprises subdividing interactions of a group of interactions into multiple subgroups of interactions, wherein the dividing is based at least partly on attributes of the interactions of the series; wherein the attributing is an iterative process that comprises attributing values to interactions of a subgroup based on a value assigned to a group in which the subgroup is contained.

17. The method according to claim 1, wherein the attributing comprises attributing values to interactions of multiple interconnected series of user interactions which are associated with multiple users.

18. The method according to claim 1, wherein the enabling of the efficient utilization of communication resources comprises reducing an amount of data communicated to the user, thereby reducing an amount of communication resources.

19. The method according to claim 1, wherein the attributing of the values is based on weights which are determined based on machine implemented statistical analysis of historical data of a plurality of series of interactions with a plurality of users.

20. The method according to claim 19, further comprising determining a weight out of the weights for each property out of a plurality of properties of sets of interactions, wherein the determining of the weight is based on frequencies of patterns of interactions having said properties.

21. The method according to claim 20, further comprising determining a weight out of the weights for each property out of a plurality of properties of sets of interactions, wherein the determining of the weight is based on relative success of sets of interactions which possess the property with respect to success of other sets of interactions.

22. The method according to claim 1, wherein at least one out of the plurality of interactions is a conversion.

23. The method according to claim 20, further comprising obtaining information indicative of relations between values previously attributed to interactions of a previously analyzed series of interactions that is associated with the conversion; wherein the attributing comprises attributing values to interactions of the previously analyzed series based on the relations and on a value attributed to the conversion based at least partly on properties of at least one interaction of the series.

24. The method according to claim 1, further comprising statistically analyzing historical data of a plurality of series of interactions with at least one user for detecting a causal relationship between different interactions types, and assigning credit to both indirect and direct interactions in the series based on the causal relationship.

25. The method according to claim 1, wherein the attribution comprises attributing the apportionments of the value based on properties which pertain to the creative media used in an advertisement involved in at least one of the respective interactions.

26. A system operable to attribute a value associated with a series of user interactions to individual interactions in the series, the system comprising:
an interface, configured to obtain information of interactions which are included in the series of interactions; and
a processor on which an attribution module is implemented, the attribution module is configured to attribute an apportionment of the value to each out of a plurality of interactions of the series, based on a calibrated attribution scheme and on properties relating to at least one interaction out of the series of interactions, thereby enabling efficient utilization of communication resources.

27. The system according to claim 26, wherein the properties comprising at least one property which is unrelated to a time in which any of the interactions occurred.

28. The system according to claim 26, wherein the attribution module is configured to attribute the apportionments of the value based on properties quantifying relative quality of the interactions.

29. A computer readable medium having computer readable code embodied therein for performing a method for attribution of a value associated with a series of user interactions to individual interactions in the series, the computer readable code comprising instructions for:
obtaining information of interactions which are included in the series of interactions;
attributing an apportionment of the value to each out of a plurality of interactions of the series, based on a calibrated attribution scheme and on properties relating to at least one interaction out of the series of interactions, thereby enabling efficient utilization of communication resources.

30. The computer readable medium according to claim 29, wherein the properties comprising at least one property which is unrelated to a time in which any of the interactions occurred.

31. The computer readable medium according to claim 29, wherein the attributing comprises attributing the apportionments of the value based on properties quantifying relative quality of the interactions.

32. The computer readable medium according to claim 29, wherein the attributing comprises attributing the apportionments of the value based on types of communication channels used by the respective interactions.

33. The computer readable medium according to claim 29, wherein the attributing comprises attributing the apportionments of the value based on properties of at least one subset of interactions of the series, wherein the subset includes multiple interactions.

34. The computer readable medium according to claim 29, wherein the attributing comprises attributing the apportionments of the value based on properties of elements that triggered interactions of the series.

35. The computer readable medium according to claim 29, wherein the attributing comprises attributing the apportionments of the value based on properties which pertain to an advertised entity associated with at least one interaction of the series of interactions.

36. The computer readable medium according to claim 29, wherein the attributing comprises attributing the apportionments of the value based on properties of at least one keyword entered by a user which triggered at least one interaction of the series.

37. The computer readable medium according to claim 29, wherein the attributing comprises attributing the apportionments of the value based on properties which pertain to an advertisement provided to a user in at least one of the interactions of the series.

38. The computer readable medium according to claim 29, wherein the attributing comprises attributing the apportionments of the value based on a pattern occurring in at least one property of the interactions across the series of interactions.

39. The computer readable medium according to claim 29, wherein a group of value-sources on which the value is based excludes any value of a series closing conversion.

40. The computer readable medium according to claim 29, wherein the attributing is preceded by dividing interactions of the series into multiple groups of interactions, wherein the dividing is based on the properties of interactions of the series; wherein the attributing comprises attributing at least one of the apportionments of the value to the respective interaction of the series, based on a group to which that interaction was grouped.

41. The computer readable medium according to claim 40, wherein the dividing is an iterative process that comprises subdividing interactions of a group of interactions into multiple subgroups of interactions, wherein the dividing is based at least partly on attributes of the interactions of the series; wherein the attributing is an iterative process that comprises attributing values to interactions of a subgroup based on a value assigned to a group in which the subgroup is contained.

42. The computer readable medium according to claim 29, wherein the attributing comprises attributing values to interactions of multiple interconnected series of user interactions which are associated with multiple users.

43. The computer readable medium according to claim 29, wherein the enabling of the efficient utilization of communication resources comprises reducing an amount of data communicated to the user, thereby reducing an amount of communication resources.

44. The computer readable medium according to claim 29, wherein the attributing of the values is based on weights which are determined based on a statistical analysis of historical data of a plurality of series of interactions with a plurality of users.

45. The computer readable medium according to claim 44, wherein the computer readable code further comprises instructions for determining a weight out of the weights for each property out of a plurality of properties of sets of interactions, wherein the determining of the weight is based on frequencies of patterns of interactions having said properties.

46. The computer readable medium according to claim 45, wherein the computer readable code further comprises instructions for determining a weight out of the weights for each property out of a plurality of properties of sets of interactions, wherein the determining of the weight is based on relative success of sets of interactions which possess the property with respect to success of other sets of interactions.

47. The computer readable medium according to claim 29, wherein the computer readable code further comprises instructions for (a) statistically analyzing historical data of a plurality of series of interactions with at least one user for detecting a causal relationship between different interactions types based on the apportionment of the value attributed to one or more out of the plurality of interactions, and for (b) assigning credit to both indirect and direct interactions in the series based on the causal relationship.

48. A computerized method for attribution of a value associated with a series of user interactions to individual interactions in the series, the method comprising executing by a processor:
repeatedly updating a calibrated attribution scheme, wherein each updating is based on historical data which is more recent than any of the previous instances of updating;
obtaining information of interactions which are included in the series of interactions; and
attributing an apportionment of the value to each out of a plurality of interactions of the series, based on the calibrated attribution scheme and on properties relating to at least one interaction out of the series of interactions, the properties comprising at least one property which is unrelated to a time in which any of the interactions occurred; thereby enabling efficient utilization of communication resources
wherein the attributing comprises attributing the apportionments of the value based on at least one of: (a) types of communication channels used by the respective interactions; (b) properties of at least one subset of interactions of the series, wherein the subset includes multiple interactions; (c) properties of elements that triggered interactions of the series.

49. The method according to claim 48, wherein the attributing comprises attributing the apportionments of the value based on at least two of: (a) types of communication channels used by the respective interactions; (b) properties of at least one subset of interactions of the series, wherein the subset includes multiple interactions; (c) properties of elements that triggered interactions of the series.
